(19) United States
(12) Patent Application Publication
(10) Pub. No.: US 2025/0108853 A1
(43) Pub. Date: Apr. 3, 2025

(54) MULTI-MODAL CONTROLLER FOR CONTROLLING VEHICLE COMPONENTS DURING OPERATION

(71) Applicant: Rivian IP Holdings, LLC, Irvine, CA (US)

(72) Inventors: Joseph DIVIRGILIO, Irvine, CA (US); Jason CHEN, Upland, CA (US); Wesley LIANG, Marina del Rey, CA (US); Christopher Marshall JACOBS, Palo Alto, CA (US); Sarah Elizabeth WITTING, Lake Forest, CA (US)

(21) Appl. No.: 18/527,876

(22) Filed: Dec. 4, 2023

Related U.S. Application Data
(60) Provisional application No. 63/541,649, filed on Sep. 29, 2023.

(51) Int. Cl. B62D 1/04

(52) U.S. Cl. CPC B62D 1/046

(57) ABSTRACT

A manual control assembly includes a multi-modal control mechanism. The manual control assembly further includes a connection socket for housing the multi-modal control mechanism on a steering controller of a vehicle, wherein an interface of the connection socket is connected to a control system for the vehicle. The manual control assembly further includes a first sensor and a second sensor for detecting actuation of the multi-modal control mechanism, wherein the first sensor is positioned orthogonal to the second sensor to detect a force applied to the multi-modal control mechanism. The manual control assembly further includes a control module for generating, based on the actuation, input signals to be transmitted to the control system to control one or more components of the vehicle.

### CROSS-REFERENCE TO RELATED APPLICATIONS

This application claims priority to U.S. Provisional Application No. 63/541,649, entitled “MULTI-MODAL CONTROLLER FOR CONTROLLING VEHICLE COMPONENTS DURING OPERATION” and filed Sep. 29, 2023, the disclosure of which is incorporated herein by reference in its entirety.

### INTRODUCTION

While operating a vehicle, a driver can control various functions of the vehicle by manipulating and/or actuating a control mechanism. Some functions of the vehicle can even be actuated without requiring the driver to move their hands (e.g., moving their hands off of a steering wheel to control a function of the vehicle). While operating the vehicle (e.g., driving), it can be desirable to enabling control over different functions of the vehicle while driving. However, it can be difficult to implement such control using conventional control mechanisms particularly control mechanisms that are ergonomic in design and intuitive in operation while being minimally distracting. These difficulties may arise from the limited manipulation and actuation options for conventional control mechanisms.

### BRIEF SUMMARY

The present disclosure describes a manual control assembly that may be integrated into a steering controller, such as the steering wheel of a vehicle, at various positions that allow for ergonomic and intuitive interaction. The manual control assembly may include a multi-modal control mechanism, such as a scroll wheel, that may be actuated in various manners to control various components of the vehicle. Different actuations of the multi-modal control mechanism may also correspond to controlling the components in different manners. The manual control assembly may include a connection socket for housing the multi-modal control mechanism and various sensors for detecting the different actuations of the multi-modal control mechanism. The manual control assembly may include a control module that generates input signals for the vehicle's control system to control various components of the vehicle.

In various embodiments, a manual control assembly includes a multi-modal control mechanism. The manual control assembly further includes a connection socket for housing the multi-modal control mechanism on a steering controller of a vehicle, wherein an interface of the connection socket is connected to a control system for the vehicle. The manual control assembly further includes a first sensor and a second sensor for detecting actuation of the multi-modal control mechanism, wherein the first sensor is positioned orthogonal to the second sensor to detect a force applied to the multi-modal control mechanism. The manual control assembly further includes a control module for generating, based on the actuation, input signals to be transmitted to the control system to control one or more components of the vehicle.

Optionally, the multi-modal control mechanism is capable of bidirectional actuation by spinning the multi-modal control mechanism around a central rotational axis.

Optionally, the input signals are generated based on a detected measurement related to rotation of the multi-modal control mechanism around the central rotational axis, the detected measurement comprising at least one of an angle of rotation, a speed of rotation, an acceleration of rotation, or a rotational force.

Optionally, the multi-modal control mechanism is capable of bidirectional actuation by applying a force to the multi-modal control mechanism along a first axis perpendicular to the central rotational axis and substantially non-parallel to a plane of rotation of the steering controller.

Optionally, the input signals are generated based on a first measurement from the first sensor being substantially greater than a second measurement from the second sensor, wherein the first measurement or the second measurement includes a force measurement or a strain measurement.

Optionally, the input signals are generated based on a detected measurement related to actuation of the multi-modal control mechanism along the first axis, the detected measurement comprising at least one of: a direction, a speed, a magnitude of force, a pressure, or a duration.

Optionally, the multi-modal control mechanism is capable of bidirectional actuation by applying a force to the multi-modal control mechanism along a second axis parallel to the central rotational axis and substantially parallel to a plane of rotation of the steering controller.

Optionally, the input signals are generated based on a first measurement from the first sensor being substantially less than a second measurement from the second sensor, wherein the first measurement or the second measurement includes a force measurement or a strain measurement.

Optionally, the manual control assembly further includes a third sensor positioned orthogonal to the first sensor and positioned parallel to the second sensor, and wherein the input signals are generated based on a first measurement from the first sensor being substantially less than a second measurement from the second sensor or a third measurement from the third sensor, wherein the first measurement, the second measurement, or the third measurement includes a force measurement or a strain measurement.

Optionally, the manual control assembly further includes a third sensor positioned orthogonal to the first sensor and positioned parallel to the second sensor, and wherein the input signals are generated based on a second measurement from the second sensor being substantially different from a third measurement from the third sensor, wherein the second measurement or the third measurement includes a force measurement or a strain measurement.

Optionally, the input signals are generated based on a detected measurement related to actuation of the multi-modal control mechanism along the second axis, the detected measurement comprising at least one of: a direction, a speed, a magnitude of force, a pressure, or a duration.

Optionally, the manual control assembly further includes a motor housed within the multi-modal control mechanism or a housing component of the connection socket.

Optionally, the manual control assembly further includes a braking mechanism, wherein a level of resistance applied to the multi-modal control mechanism by the braking mechanism is determined by the control system.

Optionally, a surface of the multi-modal control mechanism includes capacitive touch sensors, and wherein the manual control assembly is capable of generating input signals based on activation of the capacitive touch sensors.

Optionally, a surface of the multi-modal control mechanism includes pressure sensors, and wherein the manual control assembly is capable of generating input signals based on activation of the pressure sensors.

Optionally, the manual control assembly further includes a haptic actuator, wherein the manual control assembly is capable of generating haptic feedback using the haptic actuator based on signals received from the control system.

In various embodiments, a steering controller configured for installation in a vehicle includes a pair of manual control assemblies. Each of the manual control assemblies includes a multi-modal control mechanism capable of bidirectional actuation around a central rotational axis and bidirectional actuation along one or more axes; and a connection socket for housing the multi-modal control mechanism on the steering controller, wherein an interface of the connection socket is connected to a control system for the vehicle. In various embodiments, each of the manual control assemblies is capable of transmitting input signals to the control system to control components of the vehicle and capable of receiving feedback signals from the control system.

Optionally, the pair of manual control assemblies are positioned on opposite sides of the steering controller, and wherein the multi-modal control mechanism of each of the manual control assemblies is reachable by a driver's hand while positioned on the steering controller for normal driving operation.

Optionally, each of the manual control assemblies is associated with a user control context, and wherein the input signals from each of the manual control assemblies are transmitted in accordance with the user control context.

In various embodiments, a control system for a vehicle includes an electronic control unit comprising a processor and a non-transitory computer-readable medium comprising instructions executable to control one or more functions of the vehicle. The control system further includes a steering controller and a pair of manual control assemblies incorporated into the steering controller. Each of the manual control assemblies includes a multi-modal control mechanism capable of bidirectional spinning around a central rotational axis; and a connection socket for housing the multi-modal control mechanism on the steering controller of the vehicle, wherein an interface of the connection socket is connected to a control system for the vehicle. In various embodiments, the manual control assemblies are capable of transmitting input signals to the electronic control unit to control components of the vehicle.

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates a front view of a steering wheel with integrated multi-modal control mechanisms, in accordance with various embodiments.

FIG. 1B illustrates a front perspective view of the steering wheel with the integrated manual control assemblies, in accordance with various embodiments.

FIG. 1C illustrates a rear perspective view of the steering wheel with the integrated manual control assembly, in accordance with various embodiments.

FIG. 1D illustrates a schematic of the manual control assembly that may be integrated into the steering wheel, in accordance with various embodiments.

FIG. 2A illustrates an exploded view of the various components of an exemplary manual control assembly.

FIG. 2B illustrates a schematic of how the motor and various other components of the manual control assembly may be assembled.

FIG. 2C illustrates a second schematic of how the motor and various other components of the manual control assembly may be assembled.

FIG. 2D illustrates a cross-section schematic of various components of an assembled manual control assembly.

FIG. 3A illustrates a driving orientation for a user's hands on the steering wheel with the integrated manual control assemblies, in accordance with various embodiments.

FIG. 3B illustrates an actuation orientation of a user's hands on the steering wheel with the integrated manual control assemblies, in accordance with various embodiments.

FIG. 3C illustrates a second actuation orientation of a user's hands on the steering wheel with the integrated manual control assemblies, in accordance with various embodiments.

FIG. 3D illustrates a third actuation orientation of a user's hand in an exemplary embodiment where the manual control assemblies are integrated into a center console of a vehicle, in accordance with various embodiments.

FIGS. 3E-3G illustrate features of the multi-modal control mechanism, in accordance with various embodiments.

FIGS. 4A-4D illustrate various axes of actuation of the multi-modal control mechanism, in accordance with various embodiments.

FIGS. 5A-5D illustrate a push actuation of the multi-modal control mechanism along a first axis, in accordance with various embodiments.

FIGS. 5E-5H illustrate a press actuation of the multi-modal control mechanism along the first axis, in accordance with various embodiments.

FIGS. 6A-6D illustrate spinning actuations of the multi-modal control mechanism around a central rotational axis, in accordance with various embodiments.

FIGS. 7A-7D illustrate shift actuations of the multi-modal control mechanism along a second axis, in accordance with various embodiments.

FIG. 8A illustrates a user interface for controlling a component of a vehicle through the multi-modal control mechanisms, in accordance with various embodiments.

FIGS. 8B-8D illustrate example control operations for various user control contexts corresponding to the actuations of the multi-modal control mechanisms, in accordance with various embodiments.

FIG. 9 illustrates steps in a method for controlling a component of a vehicle, in accordance with various embodiments.

FIG. 10 illustrates an example vehicle, in accordance with various embodiments.

FIG. 11A is a schematic of an example computer system, in accordance with various embodiments.

FIG. 11B illustrates example firmware for a vehicle ECU, in accordance with various embodiments.

### DETAILED DESCRIPTION

The present disclosure describes a manual control assembly that may be integrated into a steering controller, such as the steering wheel of a vehicle, at various positions that allow for ergonomic and intuitive interaction. The manual control assembly may include a multi-modal control mechanism, such as a scroll wheel, that may be actuated in various manners to control various components of the vehicle. Different actuations of the multi-modal control mechanism may also correspond to controlling the components in different manners.

The manual control assembly may also include a connection socket for housing the multi-modal control mechanism. The connection socket may include an interface that is connected to a control system of the vehicle. The multi-modal control mechanism being housed in the connection socket may allow the multi-modal control mechanism to also be connected to the control system of the vehicle.

The manual control assembly may also include various sensors for detecting the different actuations of the multi-modal control mechanism. The sensors may be positioned in particular arrangements to detect the various actuations that the multi-modal control mechanism is capable of. That is, the different actuations may occur in different directions from one another, and the sensors may be positioned in particular arrangements to be able to detect the actuations in the different directions.

The manual control assembly may also include a control module that is connected to the sensors. When the sensors detect an actuation of the multi-modal control mechanism, the control module may generate signals with information about the actuation. The signals may then be transmitted to the vehicle's control system to control various components of a vehicle.

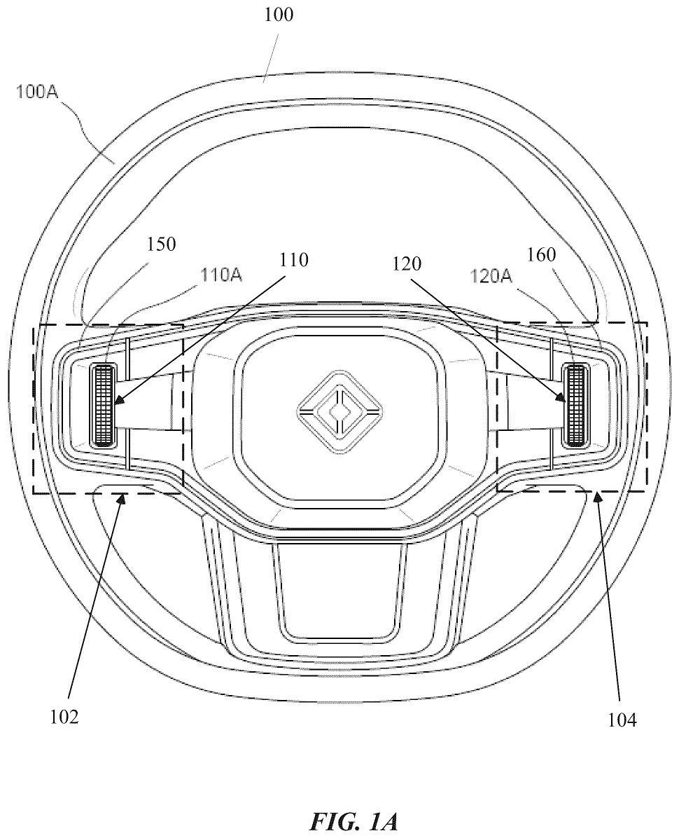

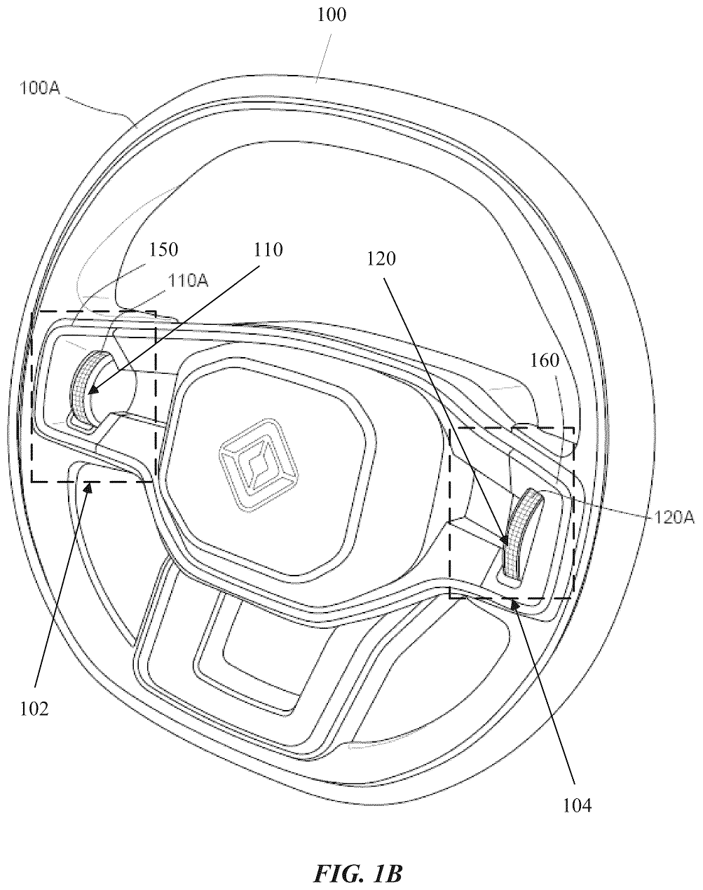

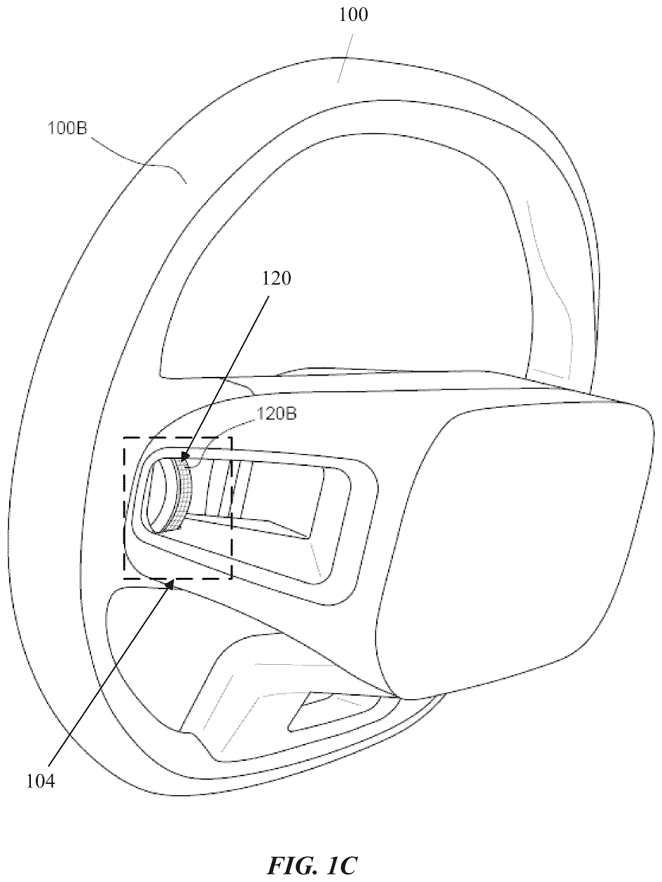

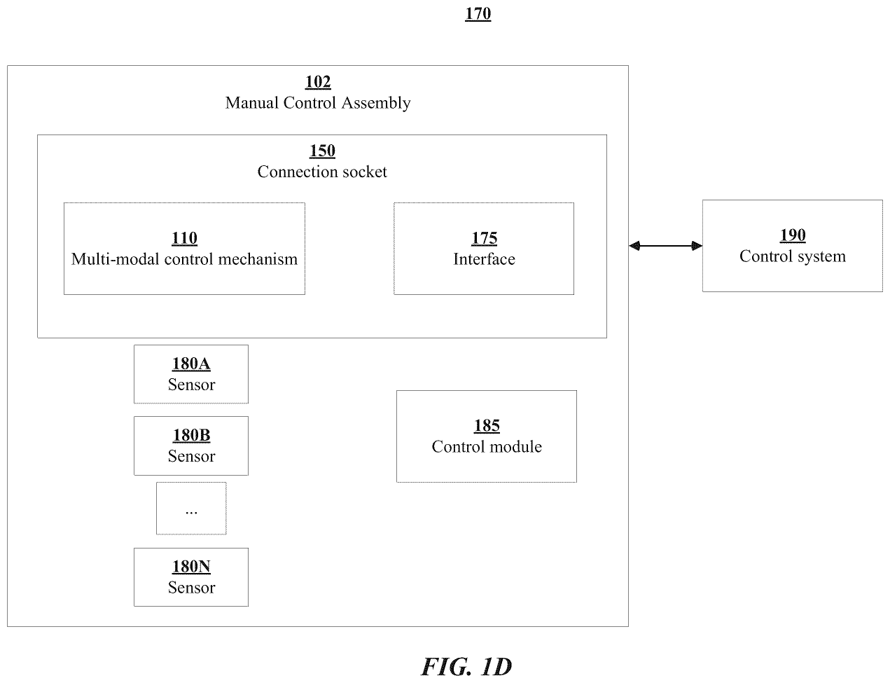

FIG. 1A illustrates a front view of a steering wheel 100 with integrated manual control assemblies 102 and 104, in accordance with various embodiments. A manual control assembly as referenced herein may be a system that a user interacts with to control various components of a vehicle and may include a multi-modal control mechanism, such as multi-modal control mechanisms 110 and 120, a connection socket for housing the multi-modal control mechanism, such as connection sockets 150 and 160, and various additional components connected or otherwise associated with the multi-modal control mechanisms 110 and 120 as described further herein. In some embodiments, a manual control assembly may include the steering wheel 100, however persons of ordinary skill in the art will recognize that the manual control assembly may not include the steering wheel 100. In the front view as illustrated in FIG. 1A, a front portion 100A of the steering wheel 100 and front portions 110A and 120A of the multi-modal control mechanisms 110 and 120 may be visible.

In various embodiments, the multi-modal control mechanisms 110 and 120 may be tactile input devices (such as scroll wheels) that receive inputs from a user (such as a driver of a vehicle) to allow the user to control various components of a vehicle. The connection sockets 150 and 160 may be any mechanical sockets which house the multi-modal control mechanisms 110 and 120 and also help connect the control mechanisms to the vehicle. For example, the connection sockets 150 and 160 may include modular housing components that house the electronics (such as a sensor or a rotary encoder) for the multi-modal control mechanisms 110 and 120 while being rigidly connected to the steering wheel 100. The connection sockets 150 and 160 may also include a motor (such as an outer-rotor brushless DC motor) that is mechanically coupled (such as through a system of gears, belts, or direct coupling) to the multi-modal control mechanisms 110 and 120. In various embodiments, the multi-modal control mechanisms 110 and 120 may be coupled to the outer rotor of the motor, such as via screws or being press fit to the outer rotor. The stator of the multi-modal control mechanisms 110 and 120 may then be coupled to the modular housing components, which may also be achieved via screws. Alternatively, the connection sockets 150 and 160 may include a bracket and a bearing that allow the multi-modal control mechanisms 110 and 120 to rotate while securing the control mechanisms to the steering wheel 100. In various embodiments, the multi-modal control mechanisms 110 and 120 may be attached to the outer ring of the bearing, while the inner ring of the bearing may attach to the bracket, which in turns attaches to the armature of the steering wheel 100.

The connection sockets 150 and 160 may include an interface, such as a wiring harness or a printed circuit board (PCB). In various embodiments, the interface may connect the connection sockets 150 and 160 to a control system of a vehicle. For example, the interface may connect the connection sockets 150 and 160 to the electronic and mechanical control system of the vehicle, which may be responsible for controlling the various components of the vehicle. Specifically, the control system of the vehicle may be a series of one or more electronic control units (ECUs) and an in-vehicle controller area network (CAN) or local interconnect network (LIN). The interface may also be implemented using various architectures. For example, the connection sockets 150 and 160 may include a first PCB with the electronics of the multi-modal control mechanisms 110 and 120 (e.g., the sensors or the rotary encoder) positioned near the control mechanisms, and a second PCB with a control module for interpreting the sensor signals and communicating with a vehicle control system, where the control module is described further herein. Another example may include a single PCB with the electronics of the multi-modal control mechanisms 110 and 120 and a corresponding control module.

In various embodiments, multi-modal control mechanisms 110 and 120 being housed in the connection sockets 150 and 160 may allow the multi-modal control mechanisms 110 and 120 to also be connected to the vehicle's control system via the connection sockets' interface. As illustrated in FIG. 1A, the steering wheel 100 may include two manual control assemblies 102 and 104 positioned on opposite sides of steering wheel 100. That is, the multi-modal control mechanisms 110 and 120 and the corresponding connection sockets 150 and 160 may be positioned on opposite sides of a central area of the steering wheel 100 and along a central horizontal axis of the steering wheel. This positioning may allow the multi-modal control mechanisms 110 and 120 to be reachable by a user's hands while positioned on the steering wheel 100 for normal driving operation. Specifically, while the user's hands may be positioned along the rim of the steering wheel 100, the manual control assemblies 102 and 104 being positioned on opposite sides of the steering wheel may allow the fingers of the user's hands to reach the manual control assemblies 102 and 104 without requiring substantial adjustment of the user's hands.

The multi-modal control mechanisms 110 and 120 may be actuated in a variety of manners, which may include scrolling, pushing or pulling, shifting left or right, or tilting, among many others. Because the multi-modal control mechanisms 110 and 120 may be the component of the manual control assemblies 102 and 104 being actuated, any actuation of the multi-modal control mechanisms 110 and 120 may also be considered as an actuation of the manual control assemblies 102 and 104. The multi-modal control mechanisms 110 and 120 may be considered multi-modal due to the variety of potential actuations. Each of the manual control assemblies 102 and 104 may include one or more sensors that detect the different actuations of the multi-modal control mechanisms 110 and 120. The sensors may be integrated into the steering wheel 100, the multi-modal control mechanisms 110 and 120, and/or the connection sockets 150 and 160. The sensors may be any appropriate sensor for detecting actuations of the multi-modal control mechanisms 110 and 120. For example, the sensors may be mechanical switches that complete an electrical circuit when the multi-modal control mechanisms 110 and 120 are actuated, piezoelectric sensors that measure the force applied to the control mechanisms during an actuation, piezoresistive sensors that measure the pressure applied to the control mechanisms, capacitive touch sensors for detecting the presence of physical touch on the control mechanisms, accelerometers or gyroscopes for measuring the linear and angular velocity of the actuation among many others.

The sensors in the manual control assemblies 102 and 104 may also be positioned in particular arrangements to detect the variety of ways that the multi-modal control mechanisms 110 and 120 are actuated. For example, the multi-modal control mechanisms 110 and 120 may be pushed in a front-to-back direction (which may be the direction going into and coming out of FIG. 1A from the perspective of FIG. 1A) and shifted in a left-to-right direction. As such, the manual control assemblies 102 and 104 may each include a first sensor for detecting the force applied to the multi-modal control mechanisms 110 and 120 for the front-to-back actuation of the multi-modal control mechanisms, and a second sensor for detecting the left-to-right actuation of the multi-modal control mechanisms. In various embodiments, the front-to-back and left-to-right directions may be orthogonal to one another. In these embodiments, the sensors for detecting actuations in those directions may also be positioned orthogonal to one another to allow the sensors to detect both actuations. In various other embodiments, the sensors may leverage certain geometry that allows the first and second sensors to be positioned parallel to one another and still detect the forces corresponding to the left-to-right and front-to-back actuations. The geometry may translate the stress uniquely through the connection sockets 150 and 160 depending on the actuation angle when a user actuates the multi-modal control mechanisms 110 and 120. That is, when a user actuates the multi-modal control mechanisms 110 and 120, the connection sockets 150 and 160 may be altered at the micron level depending on the angle of the user's actuation. The sensors may detect the changes to the connection sockets 150 and 160 due to the geometry of their positioning, and the sensor data may then be interpreted to determine what the actuation was.

In various embodiments, the sensors for detecting the multi-modal control mechanisms' actuations may be integrated into the steering wheel 100, or another location of the vehicle close (e.g., with 1-3 feet) to the steering wheel. The sensors may be communicatively coupled to the multi-modal control mechanisms 110 and 120 upon the multi-modal control mechanisms being housed in the connection sockets 150 and 160. In various embodiments, the sensors that detect the multi-modal control mechanisms' actuations may also be integrated into the multi-modal control mechanisms 110 and 120. These sensors may be communicatively coupled to the vehicle together with the multi-modal control mechanisms 110 and 120. In one or more examples, the sensors may couple to the vehicle when the multi-modal control mechanisms 110 and 120 are housed in the connection sockets 150 and 160.

In various embodiments, each of the manual control assemblies 102 and 104 may also include one or more control modules that are connected to the sensors. When the sensors detect an actuation of the multi-modal control mechanisms 110 and 120, the control modules may generate signals corresponding to the detected actuation. The signals may be transmitted to the vehicle's control system. That is, the control modules may generate signals that include various information about the actuation that the sensors detected, such as what the actuation was (e.g., a press, scroll, tilt, etc.), attributes about the actuation (e.g., the speed of actuation, the force applied, the direction, the angle, etc.), or other information. The signals may be transmitted to the vehicle's control system which may then process the signals to cause corresponding effects to various components of the vehicle, such as to cause a component of the vehicle to execute an action. The control modules may also receive various feedback signals from the vehicle control system in response to the signals with information about the actuation. The control modules may cause the manual control assemblies to perform an action based on the feedback signals. For example, the control modules may receive feedback signals that indicate the manual control assemblies 102 and 104 should generate a sensory feedback, such as haptic feedback, auditory feedback, or visual feedback. The control modules may then cause one or more haptic actuators in each of the manual control assemblies 102 and 104 to generate a haptic feedback to a user. The control modules may include any appropriate hardware component connected to the sensors that generates a corresponding signal when the sensors detect an actuation of the multi-modal control mechanisms 110 and 120. For example, the control modules may be various ECUs that are connected to the sensors. In various embodiments, the control modules may also be integrated into the interface of the connection sockets 150 and 160, but the control modules may also be implemented separately from the connection sockets 150 and 160. In various embodiments, the lighting elements may include a proximity sensor for detecting the proximity of an object, such as the user, to the lighting elements, where the proximity may correspond to various actuations of the multi-modal control mechanisms 110 and 120.

In various embodiments, each of the manual control assemblies 102 and 104 may also include lighting elements for illuminating various sections of the control assembly. In one or more examples, the lighting elements may be integrated into various sections of the manual control assemblies 102 and 104, the steering wheel 100, or both. For example, the lighting elements may be integrated into the steering wheel 100, the connection sockets 150 and 160, an area around the connection sockets 150 and 160, or the multi-modal control mechanisms 110 and 120. The illumination from the lighting elements may help guide a user's hands to various sections of the control assembly after the user had moved their hands away. In some examples, the lighting elements may be light strips that are attached along the circumference of the multi-modal control mechanisms 110 and 120. In some examples, the lighting elements may also be light sources positioned inside of various components of the manual control assemblies 102 and 104. For example, the lighting elements may be light sources positioned inside of the multi-modal control mechanisms 110 and 120 that produces light that radiates outwards from the multi-modal control mechanisms.

The manual control assembly may also include a haptic actuator for generating haptic feedback for the user. The haptic actuator may be implemented using any appropriate haptic device, such as linear resonant actuators (LRA), eccentric rotating mass (ERM) actuators, or a brushless DC motor, among many others. The haptic feedback generated may be based on the signals that the haptic actuator receives from the manual control assembly's control module, which may have in turn received signals from the vehicle's control system, as described above. [ ]

In various embodiments, each of the manual control assemblies 102 and 104 may also include a braking mechanism to control the actuations of the multi-modal control mechanisms 110 and 120 by applying a level of resistance to the multi-modal control mechanisms. The braking mechanism may be implemented based on the implementation of the multi-modal control mechanisms 110 and 120. For example, the multi-modal control mechanisms 110 and 120 may be implemented as scroll wheels, and the braking mechanism may be implemented as springs that press against the scroll wheels to provide resistance as the scroll wheels are scrolled. In various embodiments, the braking mechanism may also be implemented using a brushless DC motor. The level of resistance that the braking mechanism applies may be determined by the vehicle's control system. One or more techniques may be used to determine the level of resistance. For example, the multi-modal control mechanisms 110 and 120 may be associated with controlling a vehicle's infotainment, and the vehicle's control system may determine the level of resistance of the braking mechanism based on what is being changed on the infotainment via the control mechanisms.

While the exemplary manual control assemblies 102 and 104 are illustrated and described as being integrated into a steering wheel, various other implementations may be appropriate. For example, the manual control assemblies 102 and 104 may also be integrated into various other steering controllers, such as handlebars, grips, knobs, joysticks, trackballs, among others. The manual control assemblies 102 and 104 may also be integrated at various positions along the rim of the steering wheel 100, and may not be limited to being integrated along the central horizontal axis of the steering wheel 100. In various embodiments, the manual control assemblies 102 and 104 may also be integrated into various other parts of the vehicle that is also easily accessible by a user during normal driving operation. For example, the manual control assemblies 102 and 104 may be integrated into the center console between the front seats of the vehicle.

FIG. 1B illustrates a front perspective view of the steering wheel 100 with the integrated manual control assemblies 102 and 104. As shown in FIG. 1B, the multi-modal control mechanisms 110 and 120 may be implemented in the shape of a cylinder, however, control mechanisms 110 and 120 may alternatively be implemented in various other shapes, such as spheres. In some examples, multi-modal control mechanism 110 may have a first shape (e.g., a cylinder) while multi-modal control mechanism 120 may have a second shape (e.g., a sphere). The connection sockets 150 and 160 that house the multi-modal control mechanisms 110 and 120 may include openings where the multi-modal control mechanisms 110 and 120 may be positioned and then secured. The openings may also be adjusted to match the shape of the multi-modal control mechanisms 110 and 120. Positioning the multi-modal control mechanisms 110 and 120 in the openings may also mean the multi-modal control mechanisms 110 and 120 are positioned at least partially through the connection sockets 150 and 160 and the steering wheel 100.

FIG. 1C illustrates a rear perspective view of the steering wheel 100 with the integrated manual control assembly 104. While the front portion 100A of the steering wheel 100 may be visible from the front and front perspective views of FIGS. 1A and 1B, respectively, the rear portion 100B of the steering wheel 100 may be visible from the rear perspective view. Similarly, a rear portion 120B of the multi-modal control mechanism 120 may be visible from the rear perspective view. The rear portion 120B of the multi-modal control mechanism 120 being visible from the rear perspective view may also mean that the multi-modal control mechanism 120 extends from the front through to the back of the steering wheel 100. The rear portion 120B of the multi-modal control mechanism 120 extending outwards at least partially from the rear of the steering wheel 100 may allow the multi-modal control mechanism 120 to be actuated from the rear in addition to being actuated from the front of the steering wheel 100.

FIG. 1D illustrates a schematic 170 of the manual control assembly 102 that may be integrated into the steering wheel 100. While the schematic 170 may illustrate the manual control assembly 102, persons of ordinary skill in the art will recognize the schematic may apply similarly to the manual control assembly 104. As described above, the manual control assembly 102 may include a connection socket 150 that houses the multi-modal control mechanism 110. The connection socket 150 may include an interface 175 that is connected to the control system 190 of the vehicle. The manual control assembly 102 may include one or more sensors 180A, 180B, . . . , 180N that detect the actuations of the multi-modal control mechanism 110. The manual control assembly 102 may also include a control module 185 that generates signals corresponding to the actuation detected by the sensors 180A, 180B, . . . , 180N and transmits the signals to the control system 190.

The manual control assembly 102 may be connected to the control system 190 to transmit signals to the control system 190 which allow the control system to control various components of the vehicle. In various embodiments, signals may be transmitted from the manual control assembly 102 via the interface 175. This may mean that raw data from the sensors 180A, 180B, . . . , 180N and the signals generated by the control module 185 may be forwarded to the interface 175 and then transmitted to the control system 190. In various other embodiments, signals may be transmitted from the manual control assembly 102 via the control module 185. In various other embodiments, both the interface 175 and control module 185 may transmit signals to the control system 190.

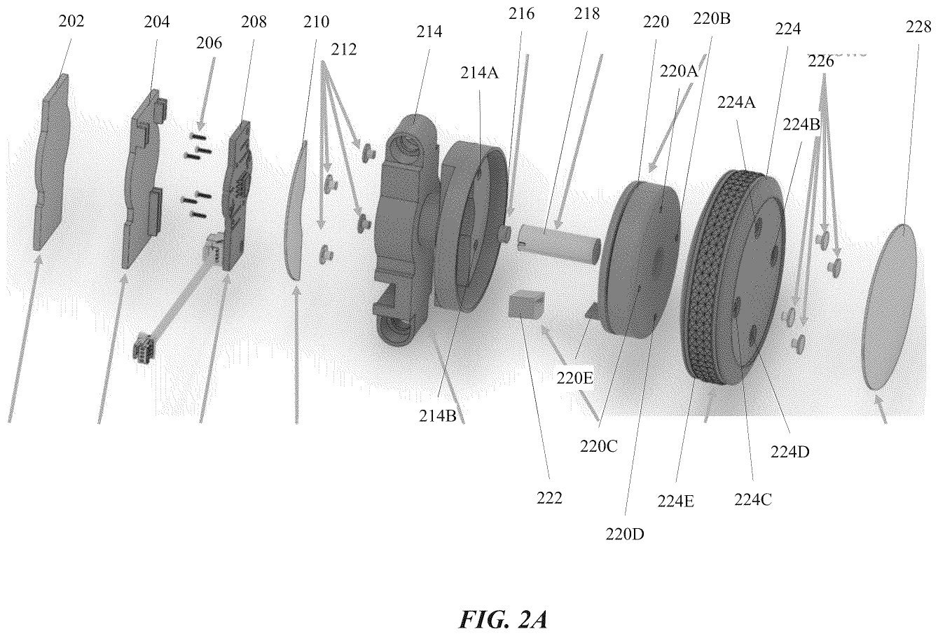

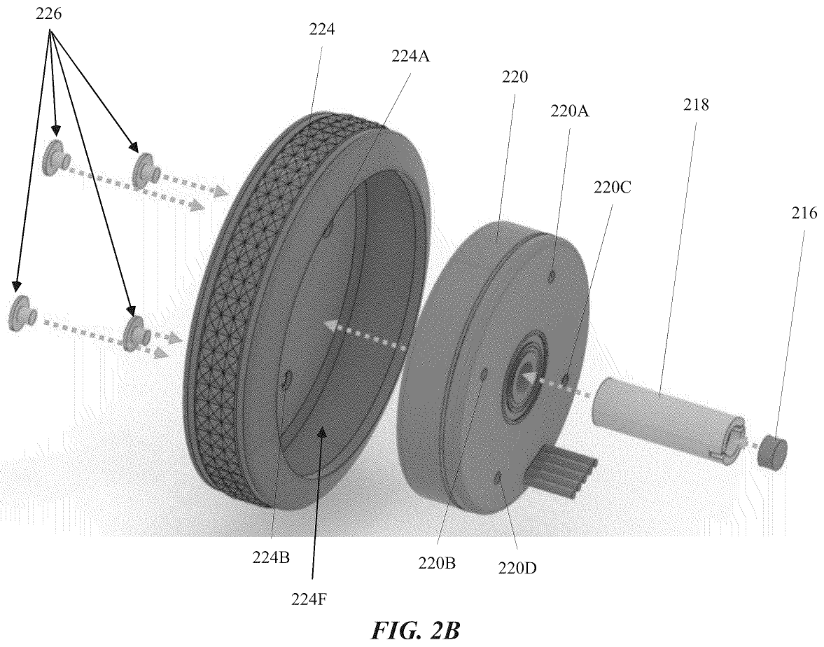

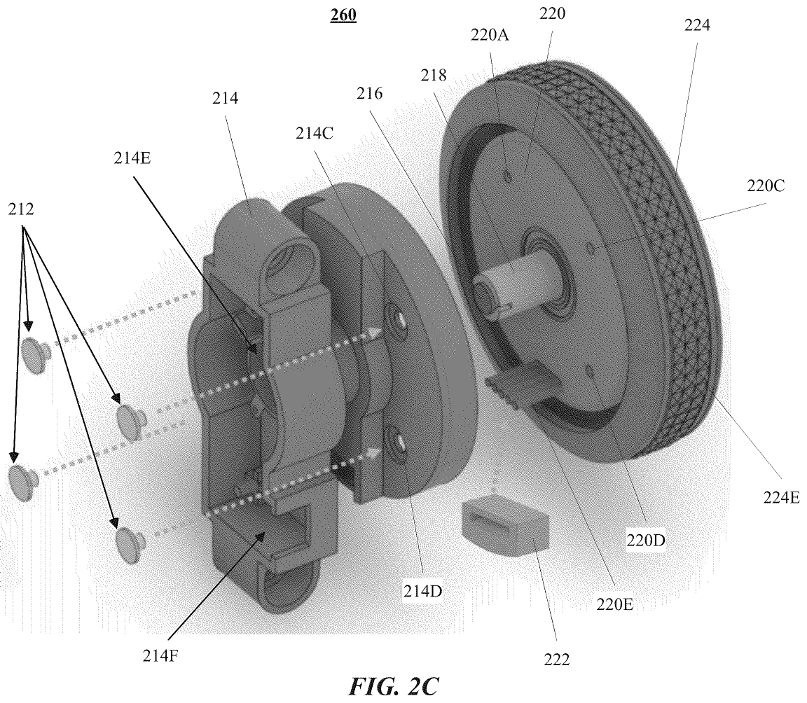

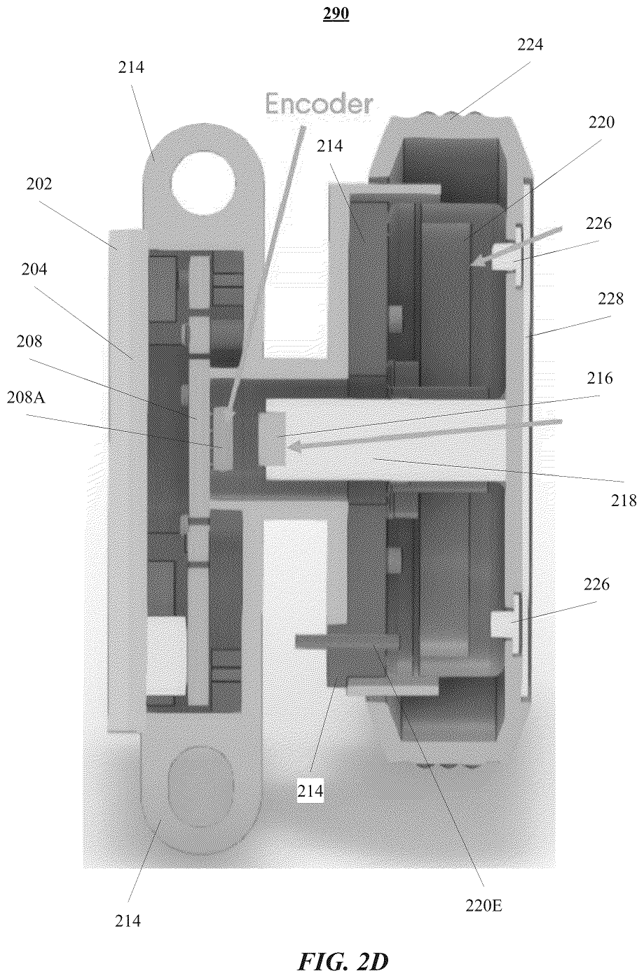

FIG. 2A illustrates an exploded view 200 of the various components of an exemplary manual control assembly, such as either of the manual control assemblies 102 and 104. The manual control assembly may include a back cover 202 to enclose and protect the manual control assembly. The back cover 202 may be attached to a back gasket 204 to protect the other components of the manual control assembly. The manual control assembly may also include an interface 208 that corresponds to the interface described above with respect to FIGS. 1A-1D. That is, the interface 208 may be a PCB that includes a rotary encoder and various force sensors for detecting actuations of the manual control assembly by a user, such as the driver of the vehicle. The interface 208 may also include a control module for processing the signals generated by the sensors of the interface 208. An inner cosmetic plate 210 may also be positioned next to the interface 208. The manual control assembly may include a set of fasteners 206 (e.g., screws) to secure the back cover 202, back gasket 204, the interface 208, and the inner cosmetic plate 210 in place. While the fasteners 206 may be illustrated between the back gasket 204 and the interface 208 in the exploded view 200, the fasteners 206 may be positioned through one or more of the back cover 202, back gasket 204, the interface 208, and the inner cosmetic plate 210 to secure the components in place in a recessed section of the housing component 214, as illustrated and described further below with respect to FIG. 2C.

The manual control assembly may also include various components associated with a motor of the manual control assembly, such as a BLDC motor as described above. Specifically, the manual control assembly may include a magnet 216, a motor shaft 218 attached to the magnet 216, and a motor 220 attached to the motor shaft 218. The manual control assembly may also include a grommet 222 for insulating and protecting the wires 220E of the motor 220. The manual control assembly may include a scroll wheel 224 which is the component a user actuates when actuating the manual control assembly, and may correspond to either of the multi-modal control mechanisms 110 and 120 as described above. The manual control assembly may also include an outer cosmetic plate 228. A second set of fasteners 212 and a third set of fasteners 226 then secures the motor 220, the scroll wheel 224, and the outer cosmetic plate 228 in place. Specifically, the second set of fasteners 212 may extend through the bores 214A and 214B of the housing component and the corresponding bores 220A-220D of the motor 220, while the third set of fasteners 226 may extend through the bores 224A-224D of the scroll wheel 224 and the corresponding bores 220A-220D of the motor to secure the components to the housing component 214 from both directions.

In various embodiments, the scroll wheel 224 may be able to scroll in an upwards or downwards direction. The scroll wheel 224 may also include a contact area 224E along the wheel's circumference that a user makes contact with when actuating the scroll wheel 224. The contact 224E may be textured and implemented using a material that provides tractions for a user's fingers. The material of the contact area 224E may also be a different material than the material of the remainder of the scroll wheel 224. For example, the body of the scroll wheel 224 may be implemented using plastic, while the contact area 224E may be implemented using rubber or silicone to provide traction and grip for a user's fingers when the scroll wheel 224 is being actuated. The contact area 224E may also include a plurality of ridges that extend along the scroll wheel's circumference. The ridges of the contact area 224E may be connected to the sensors on the interface 208 via wires to detect various aspects of the scroll wheel's actuation. This may include the direction or angle of rotation, the speed of rotation, the acceleration of rotation, or the rotational force, among many others.

In various embodiments, a surface of the scroll wheel 224 may be capacitively charged, such as the contact area 224E. The interface 208 may include capacitive touch sensors connected to the surface of the scroll wheel 224 for detecting any electrical disturbance indicating an actuation. In some embodiments, the control module of the manual control assembly may be capable of generating input signals based on the activation of the capacitive touch sensors. That is, when a user's hands makes contact with the surface of the scroll wheel 224, the capacitive touch sensors on the interface 208 may detect the user's hands which indicate an actuation of the manual control assembly. The control module may then generate the corresponding input signals with information about the capacitive actuation, such as the duration of contact or the force of contact, among others.

FIG. 2B illustrates a schematic 230 describing how the motor and various other components of the manual control assembly may be assembled. As described above, the manual control assembly may include a BLDC motor, and thus include a magnet 216, a motor shaft 218 attached to the magnet 216, and a motor 220 attached to the motor shaft 218. The magnet 216 may be inserted into a central opening of the motor shaft 218, which is in turn inserted into a central opening of the motor 220. The motor 220 may then be inserted into and secured to a recessed section 224F of the scroll wheel 224. Specifically, the third set of fasteners 226 may insert through bores 224A-224D of the scroll wheel 224 (with only two of the bores illustrated in FIG. 2B) and the corresponding bores 220A-220D of the motor 220 to secure the motor 220 to the recessed section 224F of the scroll wheel 224. This allows the motor 220 to be positioned inside of the scroll wheel 224.

FIG. 2C illustrates a second schematic 260 of how the motor and various other components of the manual control assembly may be assembled. In the second schematic 260, the BLDC motor may be assembled and secured to the scroll wheel 224, with the magnet 216 inserted into the motor shaft 218, which is in turn inserted into the motor 220 and positioned in the recessed section of the scroll wheel 224. Additionally, the grommet 222 may be positioned around the wires 220E of the motor 220 to insulate and protect the wires. The motor shaft 218 may then be inserted into a central opening 214E of the housing component 214, and then secured to the housing component 214 via the second set of fasteners 212 that insert through the bores 214A-214D of the housing component 214 and the corresponding bores 220A-220D of the motor 220. Combined with FIG. 2B and as described above with respect to FIG. 2A, this allows the BLDC motor of the manual control assembly to be secured to the housing component 214 from both directions. The housing component 214 may also include a recessed section 214F where one or more of the back cover 202, back gasket 204, the interface 208, and the inner cosmetic plate 210 may be positioned and then secured in place by the fasteners 206. This may allow those components to also be housed within the housing component 214.

FIG. 2D illustrates a cross-section schematic 290 of various components of an assembled manual control assembly. As described above, the manual control assembly may include a back cover 202 attached to a back gasket 204. The interface 208 may be a PCB that includes a rotary encoder 208A for converting the mechanical rotation of the scroll wheel 224 to electrical signals for the vehicle control system. Those components may be housed in the housing component 214 which may also house the various components of the BLDC motor, including the magnet 216, the motor shaft 218 and the motor 220. The motor 220 may be secured in place by at least the fasteners 226, with an outer cosmetic plate 228 as a decorative or protective cover for the manual control assembly. As illustrated by the cross-section schematic, once assembled, the motor 220 may be positioned inside of the housing component 214 as well as the scroll wheel 224. This may result in the manual control assemblies 102 and 104 as illustrated and described above with respect to FIGS. 1A-1C having an integrated motor associated with the multi-modal control mechanisms 110 and 120 exposed for a user to interact with and actuate. In some embodiments, housing the motor 220 within the scroll wheel 224 may enable accurate haptic feedback control within a small assembly area of the steering wheel 100. This configuration may enable multiple degrees of actuation during operation of the vehicle (e.g., when the user's hands are in a natural hand position on the steering wheel 100). These degrees of actuation may include, but are not limited to, pushing, pressing, shifting left, shifting right, scrolling up, and scrolling down.

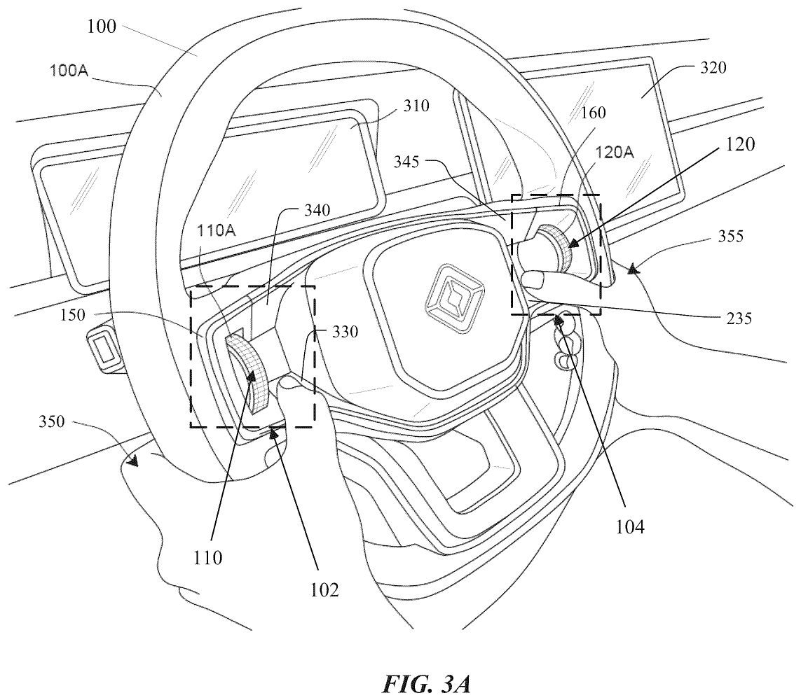

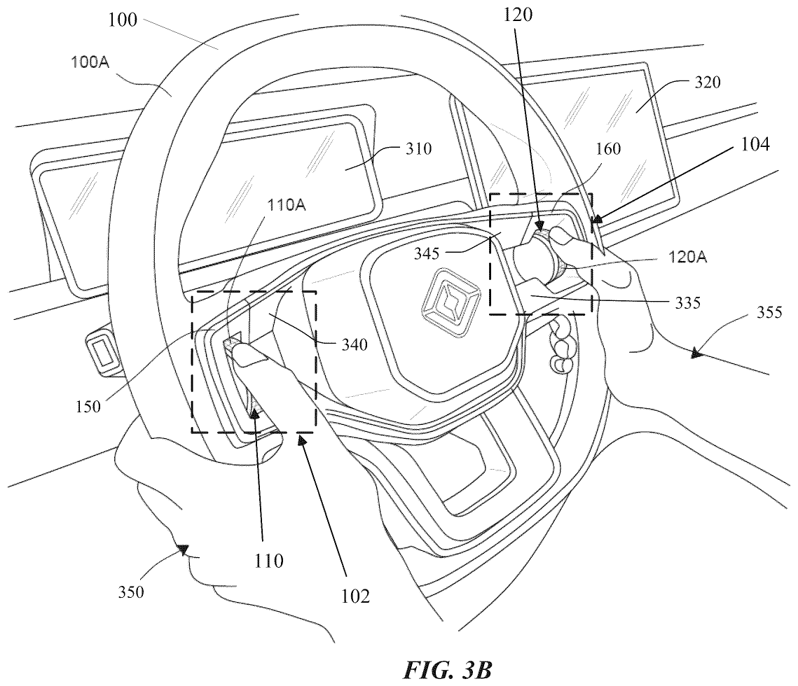

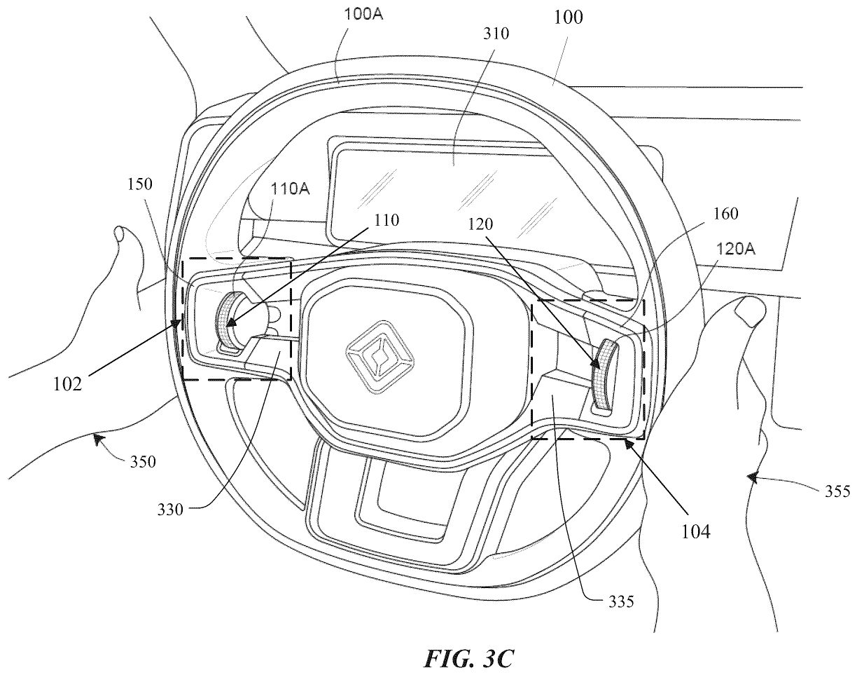

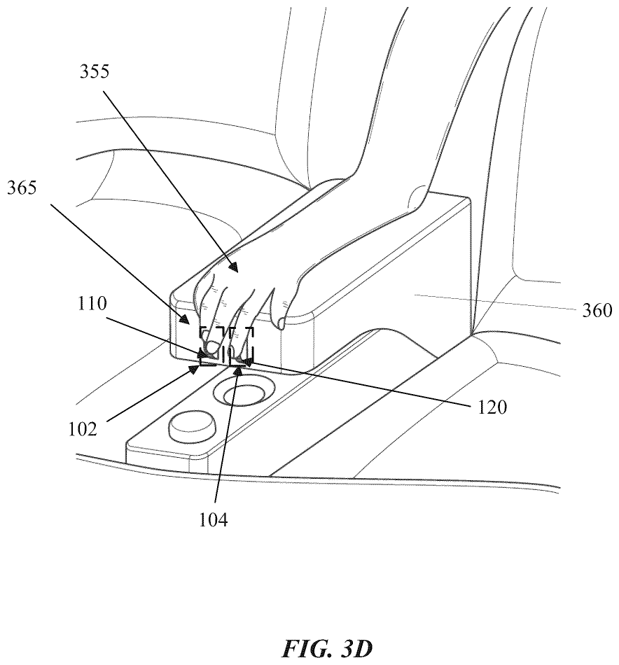

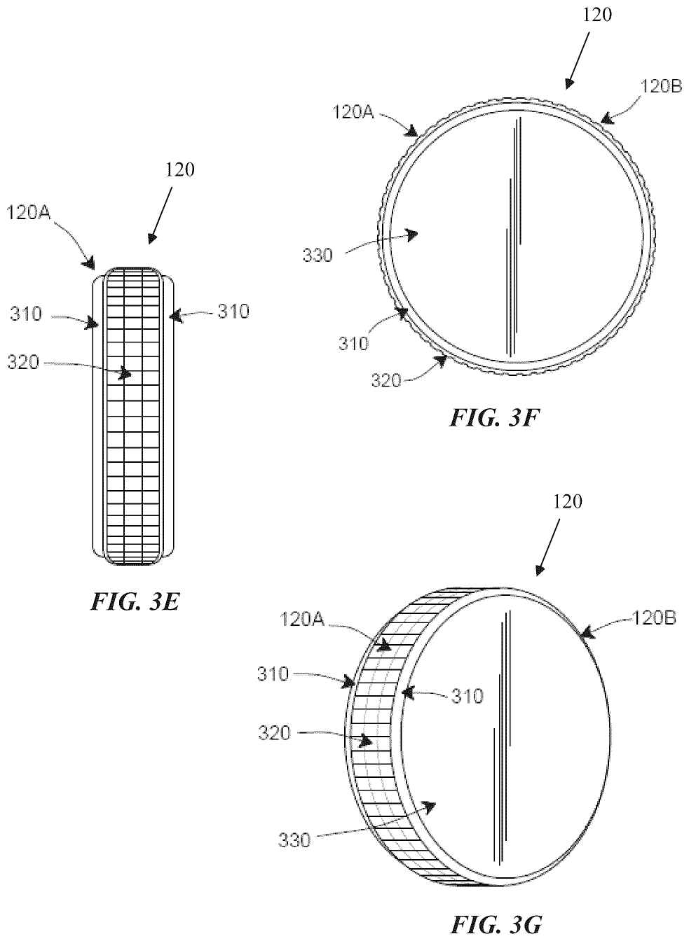

FIG. 3A illustrates a driving orientation for a user's hands 350 and 355 on the steering wheel 100 with the integrated manual control assemblies 102 and 104. The driving orientation may be the orientation of user's hands 350 and 355 when the user is not actively engaging with the manual control assemblies and actuating the multi-modal control mechanisms 110 and 120. For example, the user's hands 350 and 355 in the driving orientation may be controlling the steering wheel 100 while driving a vehicle but not actuating the multi-modal control mechanisms 110 and 120. The manual control assemblies 102 and 104 may include resting spaces 330 and 335 positioned next to the multi-modal control mechanisms 110 and 120 and in spokes 340 and 345 of the steering wheel 100. The resting spaces 330 and 335 may be where the thumbs of the user's hands 350 and 355 rest while in the driving orientation. The proximity of the resting spaces 330 and 335 to the multi-modal control mechanisms 110 and 120 may allow the user to just move their thumbs a short distance from the resting spaces when actuating the multi-modal control mechanisms. This also means that the multi-modal control mechanisms 110 and 120 may be reachable by the user's hands 350 and 355 while the hands are positioned on the steering wheel 100 for normal driving operation. This may also allow for intuitive and ergonomic actuation of the multi-modal control mechanisms 110 and 120.

In various embodiments, the multi-modal control mechanisms 110 and 120 may be positioned in the spokes 340 and 345 of the steering wheel 100, as compared to along the rim of the steering wheel itself, to reduce unintentional actuation of the control mechanisms in the normal course of controlling the steering wheel while driving. This may also help the ergonomics of actuating the multi-modal control mechanisms 110 and 120.

The different actuations of the multi-modal control mechanisms 110 and 120 may correspond to various components of the vehicle, such as a dash 310 or an infotainment system 320, performing one or more actions. For example, one actuation of the multi-modal control mechanisms 110 and 120 may be a push actuation that is described further herein. A push actuation of multi-modal control mechanisms 110 and/or 120 may correspond to a selection being made on the dash 310 or the infotainment system 320. As another example, actuation of multi-modal control mechanisms 110 and 120 may be a spinning/twisting actuation, described in greater detail herein. A spinning/twisting actuation may correspond to adjusting a level and/or setting of one or more systems of the vehicle (e.g., climate and/or volume systems).

Each of the multi-modal control mechanisms 110 and 120 may also be associated with a user control context, which as referenced herein may include the aspect or component of the vehicle being controlled by the actuations of the multi-modal control mechanisms 110 and 120, as well as the corresponding electrical and mechanical controls of the vehicle for controlling that aspect or component. For example, the multi-modal control mechanism 110 may be associated with a user control context corresponding to the vehicle's climate controls, which may allow the multi-modal control mechanism 110 to execute various actions with respect to the climate controls. The multi-modal control mechanism 120 may be associated with the user control context corresponding to the vehicle's infotainment, which may allow the multi-modal control mechanism 120 to execute various actions with respect to the infotainment. The input signals that the manual control assemblies' control modules generate and transmit to the vehicle's control system may also be based on the user control contexts associated with the multi-modal control mechanisms 110 and 120. As referenced herein, any association or relation between a user control context and a multi-modal control mechanism may apply to the manual control assembly that the multi-modal control mechanism is a part of.

The multi-modal control mechanisms 110 and 120 may alternatively or additionally be associated with a single user control context instead of separate user control contexts. For example, instead of one control mechanism being associated with the vehicle's climate system and the other control mechanism being associated with the vehicle's infotainment system, both of the multi-modal control mechanisms 110 and 120 may be associated with the same user control context, such as a driving context to execute a maneuver like a tank-turn. Whether the multi-modal control mechanisms 110 and 120 are associated with one or multiple user control contexts may also be configured by the vehicle's control system.

In some embodiments, the haptic feedback generated by the multi-modal control mechanisms 110 and 120 may be based on the user control contexts associated with the multi-modal control mechanisms. For example, different haptic feedback may be generated for the same actuation if one control mechanism is associated with the climate system while another control mechanism is associated with the volume system. For example, a multi-modal control mechanism may generate detents as a user actuates the control mechanism to scroll through various selections in a control context, and the quantity of detents generated per revolution may differ depending on the control context. If the multi-modal control mechanism is associated with the volume system, the multi-modal control mechanism may generate a detent for each volume level, so the control mechanism may generate 20 detents per revolution. If the multi-modal control mechanism is associated with a driving mode selection, the multi-modal control mechanism may generate a detent for each driving mode, so the control mechanism may instead only generate four detents per revolution. In some embodiments, the haptic feedback may be determined by the vehicle's control system based on the user control context associated with the multi-modal control mechanisms 110 and 120.

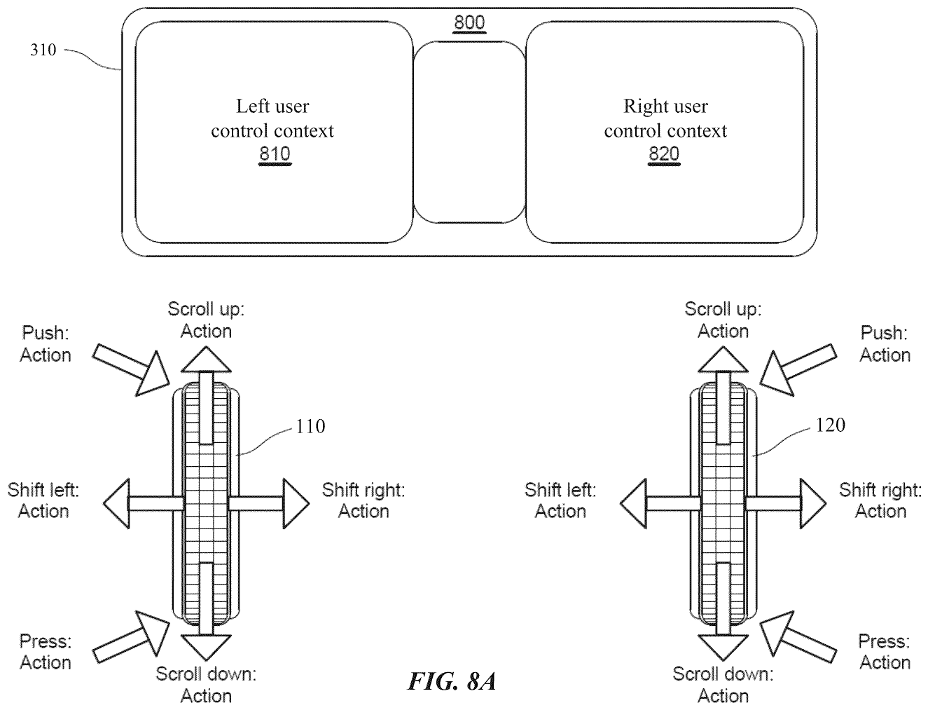

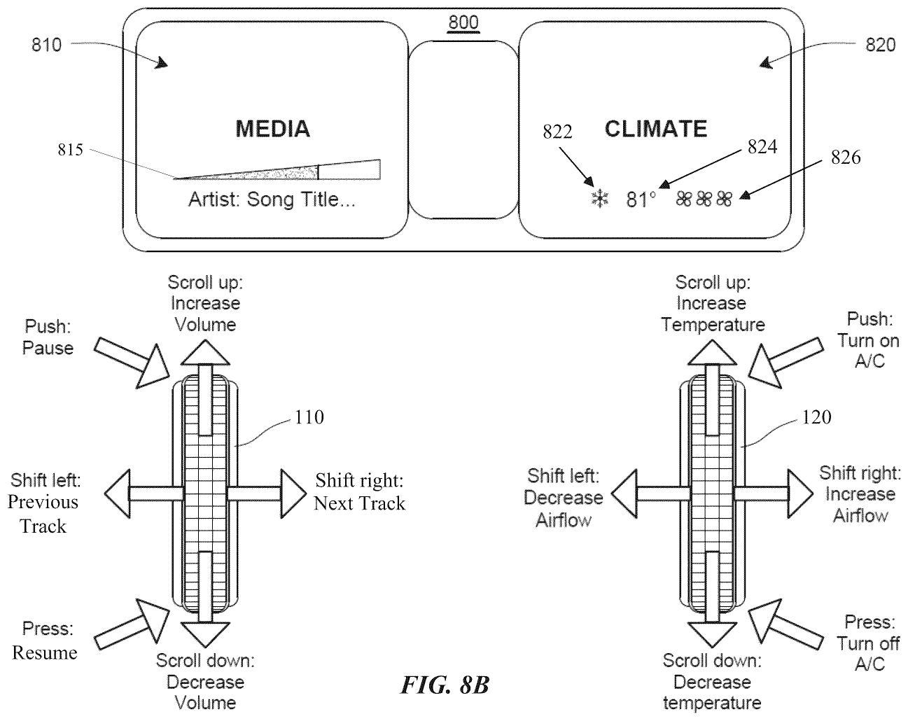

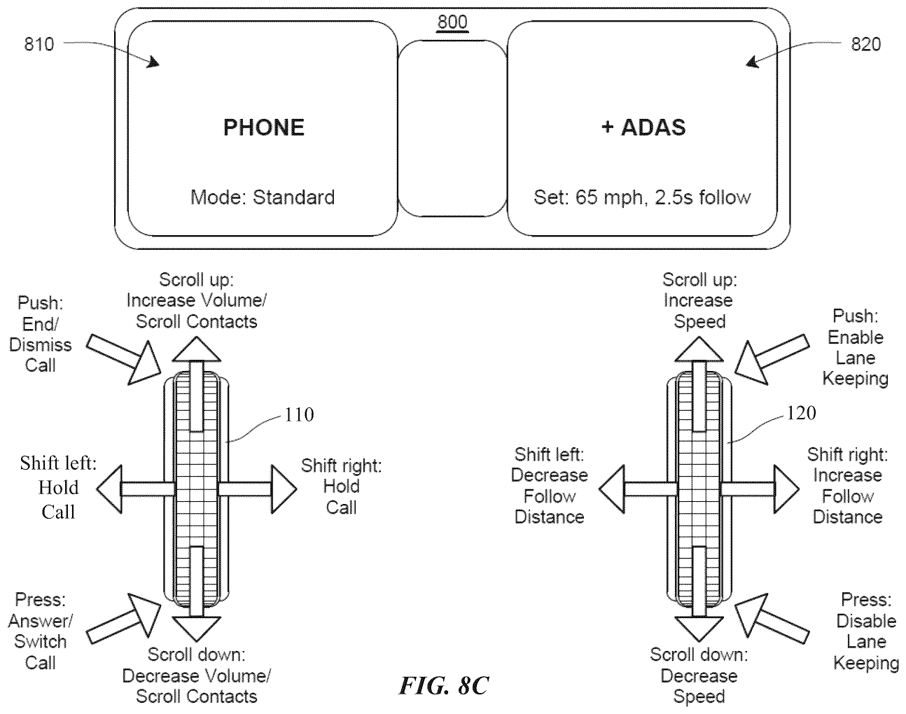

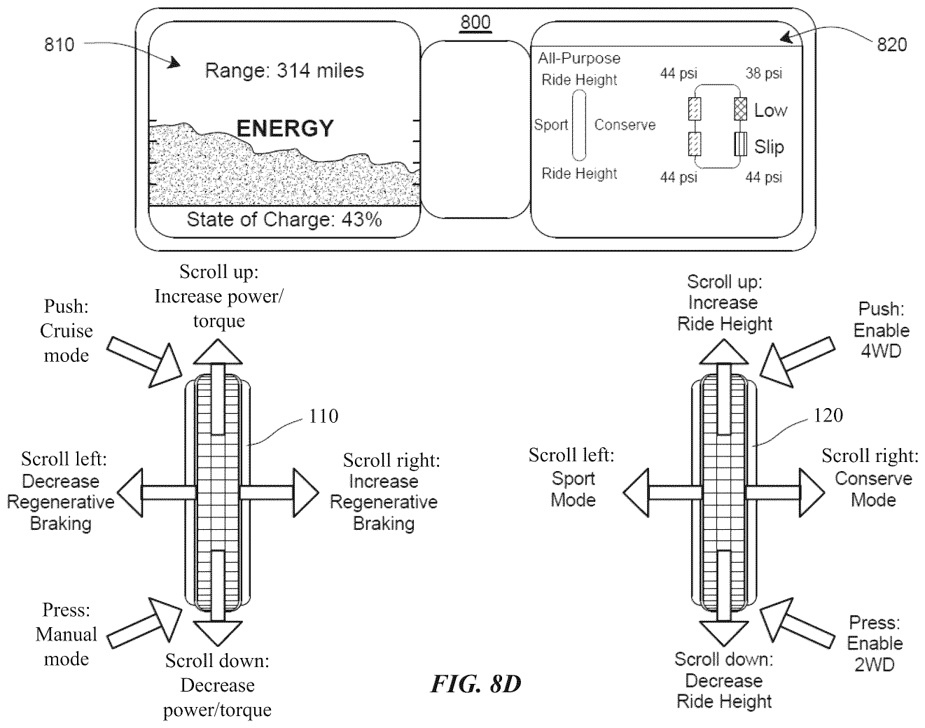

The multi-modal control mechanisms 110 and 120 may improve the user's ability to navigate a user interface (e.g., visual component 800 of FIG. 8) efficiently while minimizing distractions while driving. Using the multi-modal control mechanisms 110 and 120, the user can control vehicle functions while driving without repositioning the hands or looking away from the road. The multi-modal control mechanisms 110 and 120 may also enable the user to precisely control vehicle functions (e.g., ride height, following distance, etc.) without repositioning the hands or looking away from the road.

FIG. 3B illustrates an actuation orientation of a user's hands 350 and 355 on the steering wheel 100 with the integrated manual control assemblies 102 and 104. The actuation orientation of the user's hands 350 and 355 may be the orientation when the user's hands are positioned to actuate the multi-modal control mechanisms 110 and 120. The adjustment from the driving orientation of FIG. 3A to the actuation orientation of FIG. 3B may be minimal due to the proximity of the multi-modal control mechanisms 110 and 120 to the user's hands 350 and 355 while the user was not actuating the multi-modal control mechanisms. For example, adjusting to the actuation orientation may include shifting the thumbs of the user's hands 350 and 355 from the resting spaces 330 and 335 to the multi-modal control mechanisms 110 and 120. This minimal adjustment of the user's hands 350 and 355 to move to the actuation orientation may result in the driving and actuation orientations being similar, which may allow the user to retain a similar level control of the steering wheel 100 even when actuating the multi-modal control mechanisms 110 and 120. This may also allow for an ergonomic and intuitive actuation of the multi-modal control mechanisms 110 and 120 that may also minimize distractions.

The multi-modal control mechanisms 110 and 120 may also be actuated in various manners while the user's hands 350 and 355 are in the actuation orientation. For example, the thumbs of the user's hands 350 and 355 may actuate the multi-modal control mechanisms 110 and 120 by applying a force to the multi-modal control mechanisms in the direction away from the user. This may result in a pushing actuation of the multi-modal control mechanisms 110 and 120. The thumbs of the user's hands 350 and 355 may also actuate the multi-modal control mechanisms 110 and 120 by applying a force in the direction towards or away from the center of the steering wheel 100. This may result in a shifting actuation of the multi-modal control mechanisms 110 and 120 from side to side. The thumbs of the user's hands 350 and 355 may also actuate the multi-modal control mechanisms 110 and 120 by scrolling the control mechanisms in an upward or downward direction. This may result in a spinning actuation of the multi-modal control mechanisms 110 and 120. While various potential actuations are described, persons of ordinary skill in the art will recognize that other actuations may be effectuated with different actions.

FIG. 3C illustrates a second actuation orientation of a user's hands 350 and 355 on the steering wheel 100 with the integrated manual control assemblies 102 and 104. The second actuation orientation of the user's hands 350 and 355 may also correspond to the user's hands being positioned to actuate the multi-modal control mechanisms 110 and 120. The second actuation orientation may differ from the first actuation orientation described in FIG. 3B. For example, while the first actuation orientation of FIG. 3B may include actuating the multi-modal control mechanisms 110 and 120 with the thumbs of the user's hands 350 and 355, the second actuation orientation may include actuating the multi-modal control mechanisms with one or more other fingers, palms, etc., of the user's hands. As an illustrative example, the second actuation orientation may include actuating the multi-modal control mechanisms 110 and 120 with the index or middle finger of the user's hands 350 and 355. The multi-modal control mechanisms 110 and 120 may also be actuated from the rear portions of the multi-modal control mechanisms, such as 120B of FIG. 1C. The adjustment from the driving orientation of FIG. 3A to the second actuation orientation of FIG. 3C may also be minimal. For example, the adjustment from the driving orientation to the second actuation orientation may only include shifting the user's hands 350 and 355 upwards a small distance from the driving orientation to reach the multi-modal control mechanisms 110 and 120 from the rear side of the manual control assemblies 102 and 104.

It may be noted that various embodiments of the second actuation orientation may not include the illustrated positioning of the thumbs of the user's hands 350 and 355. That is, the thumbs of the user's hands 350 and 355 may remain on the steering wheel 100, such as on the resting spaces 330 and 335 in a similar manner as that of FIG. 3A. This may allow the second actuation orientation to be similar to the driving orientation of FIG. 3A, except with various fingers of the user's hands 350 and 355 (such as the index or middle finger) positioned on a rear portion of the multi-modal control mechanisms 110 and 120. This may allow the user to retain a similar level of control of the steering wheel 100 even when actuating the multi-modal control mechanisms 110 and 120 in that manner. This may also allow for an ergonomic and intuitive actuation of the multi-modal control mechanisms 110 and 120 that may also minimize distractions.

The multi-modal control mechanisms 110 and 120 may also be actuated in various manners while the user's hands 350 and 355 are in the second actuation orientation. For example, the index or middle finger of the user's hands 350 and 355 may actuate the multi-modal control mechanisms 110 and 120 by applying a force in the direction of the user. This may result in a pushing actuation of the control mechanisms 110 and 120 toward the user. Pushing the multi-modal control mechanisms 110 and 120 from the rear of the multi-modal control mechanisms may also be referenced herein as pressing the multi-modal control mechanisms to differentiate the actuation from the pushing actuation by the thumb from the front of the multi-modal control mechanisms. The index or middle finger of the user's hands 350 and 355 may also actuate the multi-modal control mechanisms 110 and 120 by applying a force in the direction toward or away from the center of the steering wheel 100, which may result in a shifting actuation of the multi-modal control mechanisms from side to side. The index or middle finger of the user's hands 350 and 355 may also actuate the multi-modal control mechanisms 110 and 120 by scrolling the multi-modal control mechanisms in an upward or downward direction, which may result in a spinning actuation of the multi-modal control mechanisms. Persons of ordinary skill in the art will recognize that additional or alterative actuations may be effectuated with other actions, and the aforementioned are illustrative.

As described above, the manual control assemblies 102 and 104 may be integrated into various other parts of a vehicle in addition to the steering wheel, such as a center console. FIG. 3D illustrates a third actuation orientation of a user's hand 355 in an exemplary embodiment where the manual control assemblies 102 and 104 are integrated into a center console 360 of a vehicle. The user's hand 355 in the third actuation orientation may be positioned to actuate one or both of the multi-modal control mechanisms 110 and 120. In the third actuation orientation as illustrated, the user's arm may be positioned on the center console 360 with the user's hand 355 hanging over the end of the center console such that the fingers make contact with the multi-modal control mechanisms 110 and 120. The user may actuate the multi-modal control mechanisms 110 and 120 using any finger of the user's hand 355, such as the thumb, index, or middle finger. In various embodiments, the surface 365 of the center console 360 that the manual control assemblies 102 and 104 are integrated into may be sloped at an angle to provide more stability and control to the user when the user actuates the multi-modal control mechanisms 110 and 120.

The multi-modal control mechanisms 110 and 120 may be actuated in various manners while the user's hand 355 is in the third actuation orientation. For example, the index or middle finger of the user's hand 355 may actuate the multi-modal control mechanisms 110 and 120 by applying a force toward the center console 360. This may result in a pushing actuation of the multi-modal control mechanisms 110 and 120. The thumb, index, and/or middle finger of the user's hand 355 may also actuate the multi-modal control mechanisms 110 and 120 by applying a force from side to side, which may result in a shifting actuation of the multi-modal control mechanisms. The index or middle finger of the user's hand 355 may also scroll the multi-modal control mechanisms 110 and 120 in an upward or downward direction, which may result in a spinning actuation of the multi-modal control mechanisms. Persons of ordinary skill in the art will recognize that other actuations may be effectuated with different actions.

In various embodiments, a user may adjust from the driving orientation of FIG. 3A to the third actuation orientation of FIG. 3D by moving the user's hand 355 and corresponding arm away from the steering wheel 100 and positioning them on the center console 360. The manual control assemblies 102 and 104 may be integrated into particular positions on the surface 365 of the center console 360 that faces the front of the vehicle such that the user's hand 355 naturally makes contact with the multi-modal control mechanisms 110 and 120 when the corresponding arm is positioned on the center console 360. For example, the manual control assemblies 102 and 104 may be positioned on the front facing surface of the center console 360 at a distance from the top of the center console that corresponds to the average hand size of a potential user. A user may also position the user's hand 355 and the corresponding arm on the center console 360 during normal driving operation, where the positioning of the manual control assemblies 102 and 104 may result in the user's hand 355 already hanging in proximity to the manual control assemblies even when the user is not actuating the control mechanisms. The user may then make a minimal adjustment to be able to actuate the multi-modal control mechanisms 110 and 120. Both of these examples may allow for an ergonomic and intuitive actuation of the multi-modal control mechanisms 110 and 120 that may also minimize distractions. These actuation orientations may enable multiple degrees of actuation during operation of the vehicle (e.g., when the user's hands are in a natural hand position on the steering wheel 100). These degrees of actuation may include, but are not limited to, pushing, pressing, shifting left, shifting right, scrolling up, and scrolling down.

FIGS. 3E-3G illustrate features of the multi-modal control mechanism 120. FIG. 3E illustrates a front view of the control mechanism 120, FIG. 3F illustrates a right side view of the control mechanism 120, and FIG. 3G illustrates a right perspective view of the control mechanism 120. The multi-modal control mechanism 120 may be illustrated as a scroll wheel with a cylindrical shape and may be referenced as such further herein, but various other implementations of the multi-modal control mechanism may share various features with the exemplary embodiment described herein. Additionally, FIGS. 3E-3G may illustrate one of the multi-modal control mechanisms 120, but it may be noted that the other multi-modal control mechanism 110 may share similar features.

The multi-modal control mechanism 120 may include a wheel 310 that is able to scroll in an upwards or clockwise direction (as viewed with respect to FIGS. 3E and 3F, respectively), and in a downwards or counterclockwise direction (as viewed with respect to FIGS. 3E and 3F, respectively). The wheel 310 may include a contact area 320 along the wheel's circumference that a user makes contact with when actuating the multi-modal control mechanism 120. In various embodiments, the contact area 320 may be textured and implemented using a material that provides tractions for a user's fingers. The material of the contact area 320 may also be different material than the material of the wheel 310. For example, the wheel 310 may be implemented using plastic, while the contact area 320 may be implemented using rubber or silicone to provide traction and grip for a user's fingers when the multi-modal control mechanism 120 is being actuated. The contact area 320 may also include a plurality of ridges that extend along the wheel's circumference. The ridges of the contact area 320 may be connected to a plurality of sensors positioned in the body 330 of the multi-modal control mechanism 120 that detect various aspects of the wheel's actuation. This may include the direction or angle of rotation, the speed of rotation, the acceleration of rotation, the rotational force, among many others. In various embodiments, the sensors of the multi-modal control mechanism 120 may also be connected to the wheel 310. In such embodiments, the sensors may detect aspects of the wheel's actuation while the contact area 320 provides traction for a user during the actuation. In both cases, the sensors' detected measurements may be transmitted to the manual control assembly's control module which may generate signals corresponding to the detected actuation, which may then be transmitted to the vehicle's control system for controlling a vehicle component.

The body 330 of the multi-modal control mechanism 120 may be hollow or semi-hollow to allow various components to be positioned within. For example, the multi-modal control mechanism 120 may be connected to sensors for detecting a pushing or shifting actuation. In some embodiments, the components may be encased in a material, such as a plastic, rubber, foam, or other material. While the sensors for detecting various actuations may be positioned in various parts of the manual control assembly, such as the connection sockets 150 and 160, or the steering wheel 100, the sensors that detect the actuations may also be positioned in the body 330 of the multi-modal control mechanism 120. In various embodiments where the manual control assembly includes a lighting element, the lighting element may also be positioned in the body 330.

In various embodiments, a surface of the multi-modal control mechanism 120 may be capacitively charged, such as the contact area 320 of the wheel 310. The multi-modal control mechanism 120 may include capacitive touch sensors connected to the surface of the multi-modal control mechanism 120 for detecting any electrical disturbance indicating an actuation. In some embodiments, the control module of the manual control assembly that the multi-modal control mechanism 120 is a part of may be capable of generating input signals based on the activation of the capacitive touch sensors. That is, when a user's hands makes contact with the surface of the multi-modal control mechanism 120, the capacitive touch sensors may detect the user's hands which indicate an actuation of the multi-modal control mechanism. In this example, the control module may generate the corresponding input signals storing information about the capacitive actuation, such as the duration of contact or the force of contact, among others.

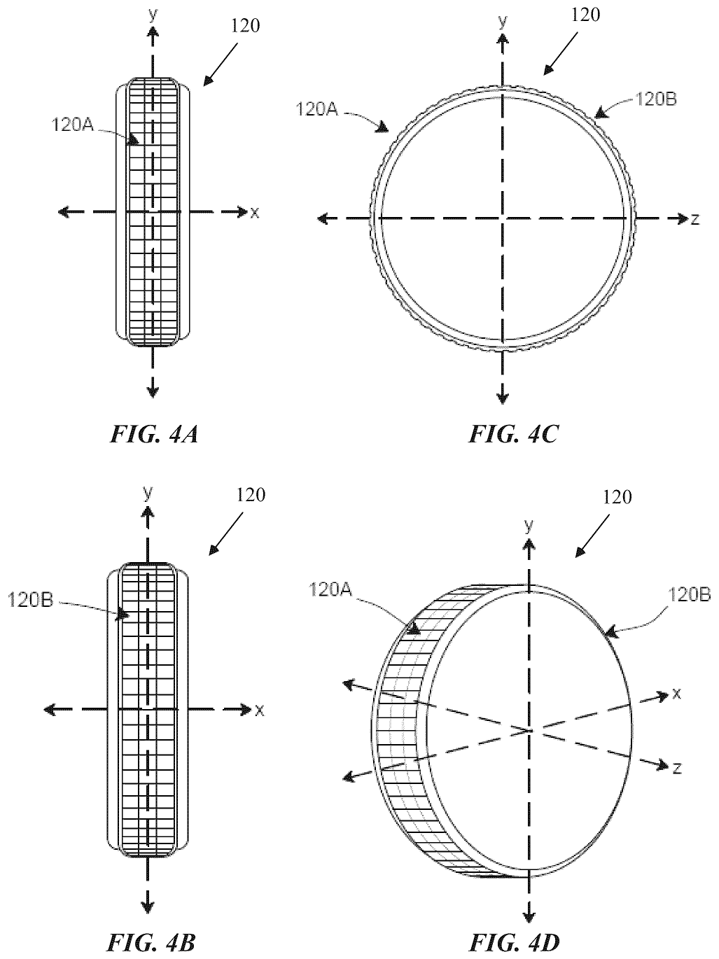

FIGS. 4A-4D illustrate various axes of actuation of the multi-modal control mechanism. FIG. 4A illustrates the axes from a front view of the multi-modal control mechanism 120. FIG. 4B illustrates the axes from a rear view of the multi-modal control mechanism 120. FIG. 4C illustrates the axes from a right view of the multi-modal control mechanism 120. FIG. 4D illustrates the axes from a right perspective view of the multi-modal control mechanism 120. Persons of ordinary skill in the art will recognize that the axes are illustrated and described herein with respect to the multi-modal control mechanism 120, but the axes may apply similarly to the multi-modal control mechanism 110. As illustrated in FIGS. 4A and 4B, two axes of actuation may be an x-axis and a y-axis. From the front and rear view, the x-axis extends horizontally from the left side of the multi-modal control mechanism 120 to the right side of the control mechanism while the y-axis extends vertically from the top to the bottom of the control mechanism. As illustrated in FIG. 4C, another axis of actuation may be a z-axis that extends from the front to the back of the multi-modal control mechanism 120. The three axes may be illustrated together in FIG. 4D. The x-axis, y-axis, and z-axis may all be perpendicular to one another. Any given actuation of the multi-modal control mechanism 120 may be with respect to one or more of the axes, while the steering wheel 100 that the control mechanism may be integrated into (such as that of FIG. 1A) may rotate in the plane that includes the x-axis and the y-axis. Thus, the plane of rotation of the steering wheel 100 as referenced further herein may be the plane that includes the X and Y axes, and it may be noted that the plane of rotation may also apply more generally to any steering controller that the multi-modal control mechanism 120 may be integrated into.

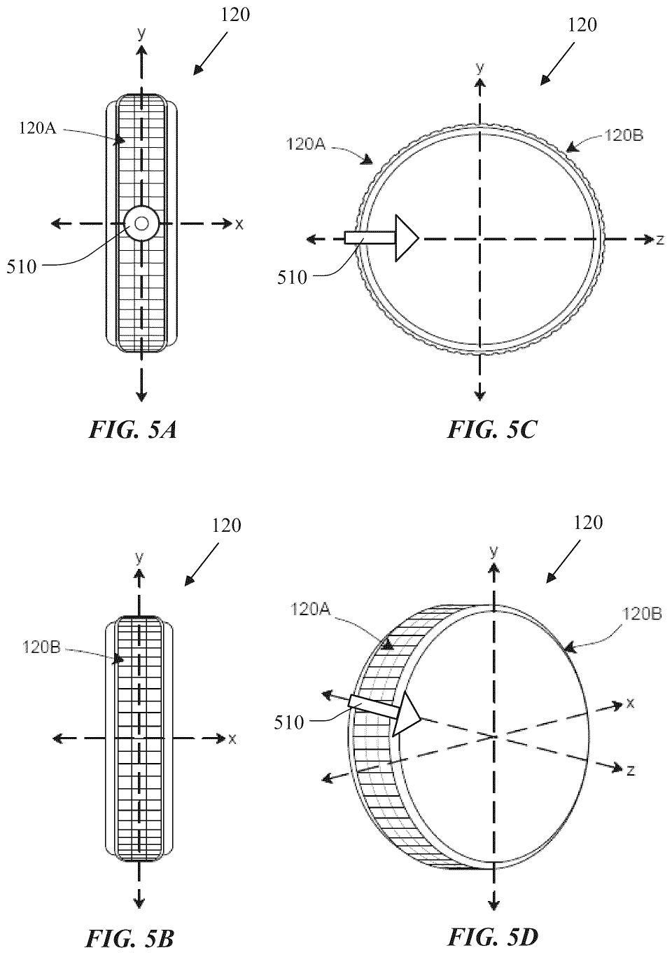

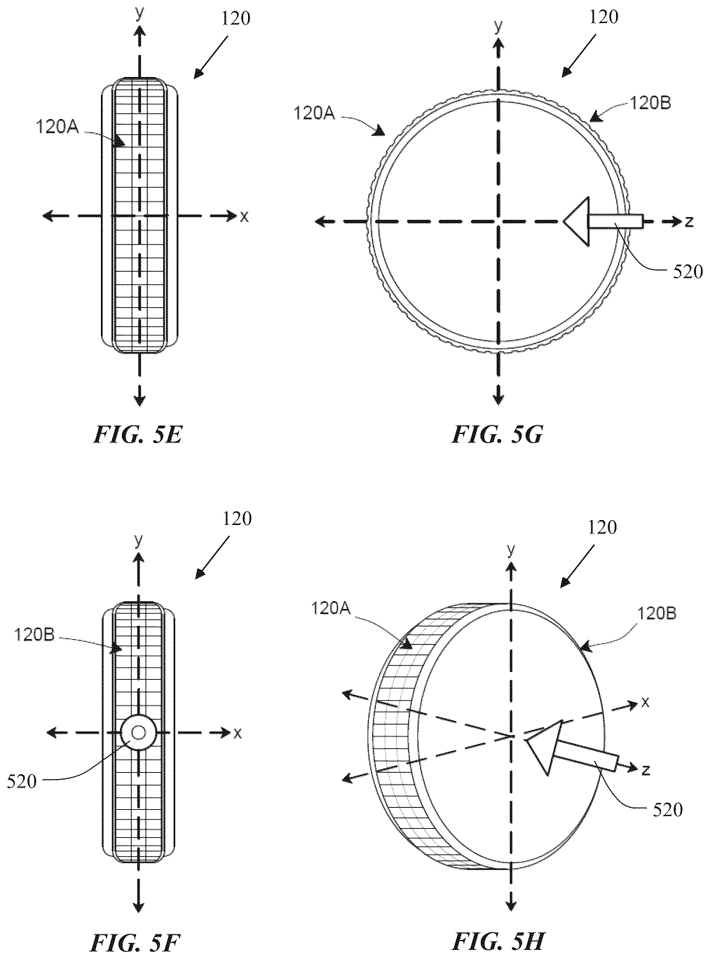

FIGS. 5A-5D illustrate a push actuation of the multi-modal control mechanism along a first axis. As referenced herein, the first axis may correspond to the z-axis as illustrated and described above with respect to FIGS. 4A-4C. FIG. 5A illustrates a front view of the push actuation of the multi-modal control mechanism 120. FIG. 5B illustrates a rear view of the push actuation of the control mechanism 120. FIG. 5C illustrates a right side view of the push actuation of the multi-modal control mechanism 120. FIG. 5D illustrates a right perspective view of the push actuation of the multi-modal control mechanism 120. Persons of ordinary skill in the art will recognize that the push actuation may be illustrated and described herein with respect to the multi-modal control mechanism 120, however the push actuation may additionally or alternatively apply similarly to the control mechanism 110.

Referring to FIGS. 5A, 5C, and 5D, the push actuation may result from a force 510 that is applied to the control mechanism 120 along the z-axis from the front toward the rear of the control mechanism. With the front of the multi-modal control mechanism 120 facing a user, such as in the examples illustrated in FIGS. 3A-3C, the user may apply the force 510 by pushing the control mechanism 120 in a direction away from the user, which may be done by using the thumbs of the user's hands 350 and 355 as illustrated in and described above with respect to FIG. 3B.

FIGS. 5E-5H illustrate a press actuation of the multi-modal control mechanism along the first axis. As described above with respect to FIG. 3C, a press actuation as referenced herein may be a force that is applied from the rear of the multi-modal control mechanism 120. FIG. 5E illustrates a front view of the press actuation of the multi-modal control mechanism 120. FIG. 5F illustrates a rear view of the press actuation of the multi-modal control mechanism 120. FIG. 5G illustrates a ride side view of the press actuation of the multi-modal control mechanism 120. FIG. 5H illustrates a right perspective view of the press actuation of the multi-modal control mechanism 120. Persons of ordinary skill in the art will recognize that the press actuation may be illustrated and described herein with respect to the multi-modal control mechanism 120, however the press actuation may apply similarly to the multi-modal control mechanism 110.

Referring to FIGS. 5F, 5G, and 5H, the press actuation may result from a force 520 that is applied to the multi-modal control mechanism 120 along the z-axis from the rear toward the front of the control mechanism. With the front of the multi-modal control mechanism 120 facing a user, such as in the examples illustrated in FIGS. 3A-3C, the user may apply the force 520 by pushing the multi-modal control mechanism 120 in a direction toward from the user, which may be done by using various fingers on the user's hands 350 and 355 (such as the index or middle finger) as illustrated in and described above with respect to FIG. 3C.

The push actuation of FIGS. 5A-5D together with the press actuation of FIGS. 5E-5H means that the multi-modal control mechanism 120 may be actuated through a push actuation by applying a force along the z-axis in a first front-to-back direction and may also be actuated through a press actuation by applying a force along the z-axis in a second back-to-front direction. In other words, the multi-modal control mechanism 120 may be capable of bidirectional actuation by applying a force to the control mechanism along the z-axis. The push and press actuations along the z-axis may be detected by the sensors of the manual control assembly that the multi-modal control mechanism 120 is a part of. The sensors may detect various aspects of the actuations, such as the direction of actuation, speed of actuation, magnitude of the force applied that resulted in the actuation, the pressure applied, the duration of actuation, among many others.

Additionally, the z-axis may be perpendicular to the plane of rotation of the steering wheel that the multi-modal control mechanism 120 is integrated into (such as that of FIG. 1A). This may be because the plane of rotation of the steering wheel includes the X and Y axes as described above, and the z-axis is perpendicular to the plane formed from those axes. Persons of ordinary skill in the art will recognize that the configuration of the z-axis in a practical implementation may not be completely perpendicular to the plane of rotation due to manufacturing tolerances and environmental conditions, among many other factors, so the relation of the z-axis to the plane of rotation of the steering wheel may be considered substantially perpendicular to account for the fact that they may be close to being but not completely geometrically perpendicular. Thus, the multi-modal control mechanism 120 may be capable of bidirectional actuation along a first axis (i.e., the z-axis) that is substantially perpendicular (and thus non-parallel) to the plane of rotation of a steering wheel or steering controller.

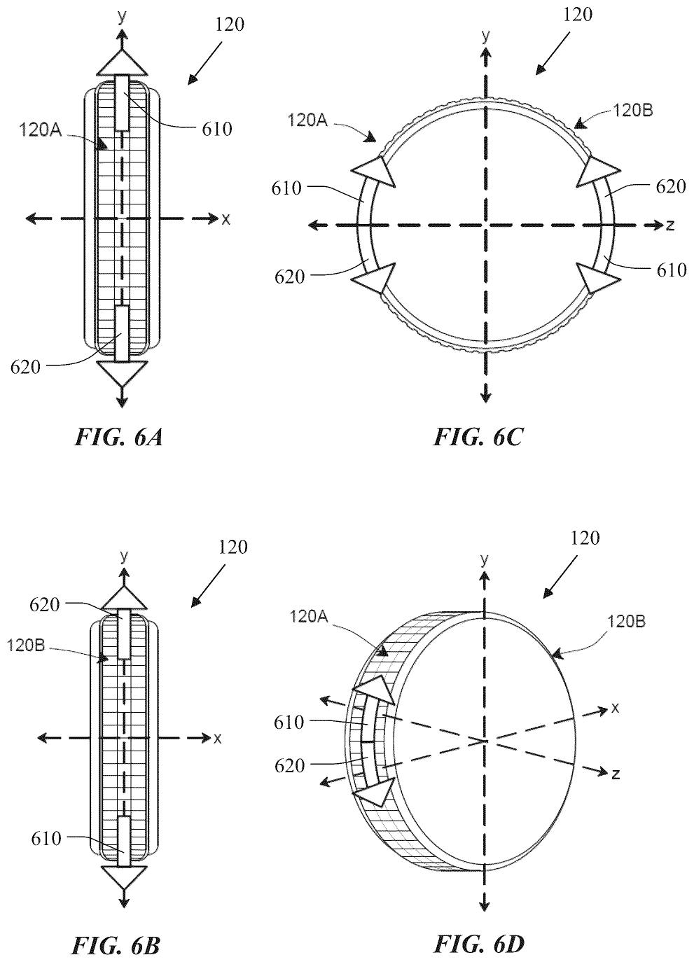

FIGS. 6A-6D illustrate spinning actuations of the multi-modal control mechanism 120 around a central rotational axis. FIG. 6A illustrates a front view of the spinning actuations of the multi-modal control mechanism 120. FIG. 6B illustrates a rear view of the spinning actuations of the multi-modal control mechanism 120. FIG. 6C illustrates a right side view of the spinning actuations of the multi-modal control mechanism 120. FIG. 6D illustrates a right perspective view of the spinning actuations of the multi-modal control mechanism 120. It may be noted that the spinning actuations may be illustrated and described herein with respect to the multi-modal control mechanism 120, but the spinning actuations may apply similarly to the multi-modal control mechanism 110.

Referring to FIG. 6A, the spinning actuations may result from a first force 610 and a second force 620 that are applied to the multi-modal control mechanism 120. First force 610 and second force 620 may be applied around the x-axis that result in the multi-modal control mechanism 120 spinning around the x-axis. The x-axis may extend through the center of the multi-modal control mechanism 120 while the control mechanism spins around the x-axis, and thus the x-axis may also be considered the central rotational axis for the spinning actuations. First force 610 may be applied in an upward direction to the multi-modal control mechanism 120 to spin the control mechanism in a first direction, and second force 620 may be applied in a downwards direction to the control mechanism to spin the control mechanism in a second direction. The spinning actuations in both directions may both be around the central rotational axis, or the x-axis. From the rear view illustrated in FIG. 6B, the direction of the forces 610 and 620 may be inverted, but the forces 610 and 620 may still result in spinning actuations of the control mechanism 120 around the x-axis and in the same directions as in FIG. 6A.

As illustrated in FIG. 6C, the first force 610 that is applied in an upward direction may result in a spinning actuation of the multi-modal control mechanism 120 in a first direction, which may correspond to a clockwise direction from the right side view. Similarly, the second force 620 may result in a spinning actuation of the multi-modal control mechanism 120 in a second direction, which may correspond to a counterclockwise direction from the right side view. Similarly in FIG. 6D, the first force 610 may result in a spinning actuation in a first direction around the x-axis, and the second force 620 may result in a spinning actuation in a second direction also around the x-axis. The forces 610 and 620 that may result in spinning actuations of the multi-modal control mechanism 120 in both directions around the x-axis may mean that the control mechanism is capable of bidirectional actuation by spinning the control mechanism around the central rotational axis, which may correspond to the x-axis.

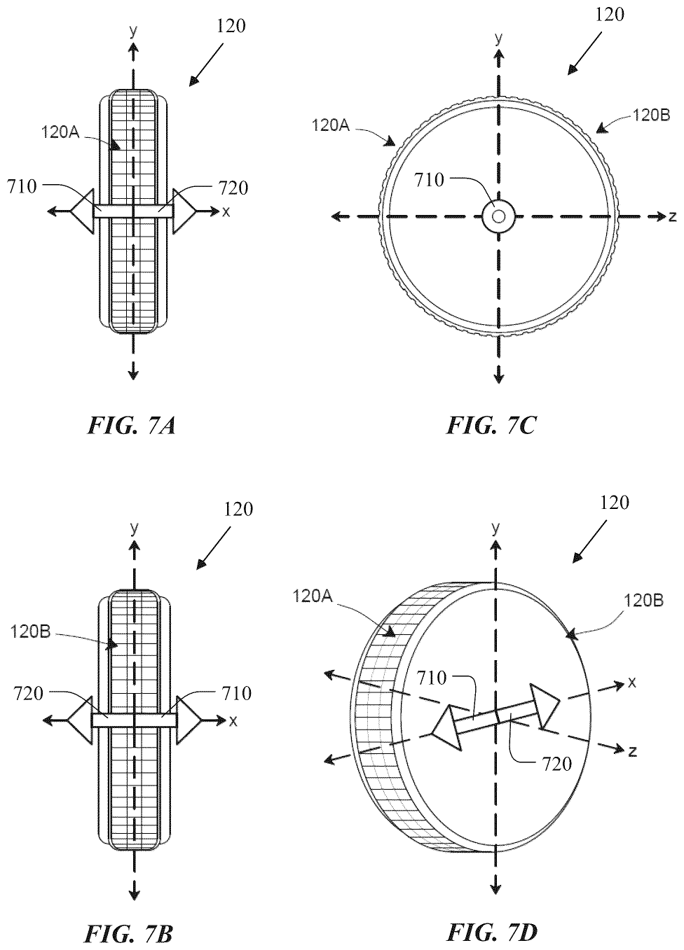

FIGS. 7A-7D illustrate shift actuations of the multi-modal control mechanism along a second axis. As referenced herein, the second axis may correspond to the x-axis as illustrated and described above with respect to FIGS. 4A-4C. FIG. 7A illustrates a front view of the shift actuations of the multi-modal control mechanism 120. FIG. 7B illustrates a rear view of the shift actuations of the control mechanism 120. FIG. 7C illustrates a right side view of the shift actuations of the control mechanism 120. FIG. 7D illustrates a right perspective view of the shift actuations of the control mechanism 120. It may be noted that the shift actuations may be illustrated and described herein with respect to the control mechanism 120, but the shift actuations may apply similarly to the control mechanism 110.

Referring to FIG. 7A, the shift actuations may result from a first force 710 and a second force 720 that are applied to the multi-modal control mechanism 120. Specifically, the forces 710 and 720 may be applied along the x-axis that results in the shift actuations of the multi-modal control mechanism 120 along the x-axis. First force 710 may be applied in a leftwards direction which may result in a shift actuation in the leftwards direction, and second force 720 may be applied in a rightwards direction which may result in a shift actuation in the rightwards direction. As such, both of the shift actuations may be along the x-axis. From the rear view illustrated in FIG. 7B, the direction of the forces 710 and 720 may be inverted, but the forces 710 and 720 may still result in shift actuations along the x-axis in both a leftward and rightward direction.

From the perspective as illustrated in FIG. 7C, the first force 710 may be applied toward the multi-modal control mechanism 120. From the perspective as illustrated in FIG. 7D, the forces 710 and 720 may be applied along the x-axis in different directions, which may result in the shift actuations of the multi-modal control mechanism 120 to be along the x-axis and in different directions. The forces 710 and 720 that result in the shift actuations of the multi-modal control mechanism 120 in both directions along the x-axis may mean that the control mechanism is capable of bidirectional actuation by applying a force along the x-axis. The shift actuations along the x-axis may be detected by the sensors of the manual control assembly that the multi-modal control mechanism 120 may be a part of. The sensors may detect various aspects of the actuations, such as the direction of actuation, speed of actuation, magnitude of the force applied that resulted in the actuation, the pressure applied, the duration of actuation, among many others.

Additionally, the x-axis may be parallel to the plane of rotation of the steering wheel that the multi-modal control mechanism 120 may be integrated into (such as that of FIG. 1A). This may be because the plane of rotation of the steering wheel includes the X and Y axes as described above, and the x-axis is parallel to the plane formed from those axes. Persons of ordinary skill in the art will recognize that the configuration of the x-axis in a practical implementation may not be completely parallel to the plane of rotation due to manufacturing tolerances and environmental conditions, among many other factors, so the relation of the x-axis to the plane of rotation of the steering wheel may be considered substantially parallel to account for the fact that they may be close to being but not completely geometrically parallel. Thus, the multi-modal control mechanism 120 may be capable of bidirectional actuation along a second axis (e.g., the x-axis) that is substantially parallel to the plane of rotation of the steering wheel or steering controller.

In various embodiments, the multi-modal control mechanisms 110 and 120 may be capable of one or more of the push actuation (described above with respect to FIGS. 5A-5D), the press actuation (described above with respect to FIGS. 5E-5H), the spinning actuations (described above with respect to FIGS. 6A-6D), and the shift actuations (described above with respect to FIGS. 7A-7D). This means the axes that the various actuations of the multi-modal control mechanisms 110 and 120 operate on may also be referenced with respect to one another. For example, the spinning actuations described with respect to FIGS. 6A-6D may include the multi-modal control mechanisms 110 and 120 spinning around the central rotational axis which corresponds with the x-axis. The push and press actuations described with respect to FIGS. 5A-5H may include applying a force to the multi-modal control mechanisms 110 and 120 along the z-axis. Since the z-axis may be perpendicular to the central rotational axis as the latter corresponds to the x-axis, the push and press actuations may mean the multi-modal control mechanisms 110 and 120 are capable of bidirectional actuation by applying a force along the first axis (corresponding to the z-axis) that is perpendicular to the central rotational axis. Similarly, the shift actuations described with respect to FIGS. 7A-7D may include applying a force to the control mechanisms 110 and 120 along the x-axis. Since the x-axis may be parallel to the central rotational axis as the latter corresponds to the x-axis, the shifting actuations may mean the multi-modal control mechanisms 110 and 120 are capable of bidirectional actuation by applying a force along the second axis (corresponding to the x-axis) that is parallel to the central rotational axis.

The multi-modal control mechanisms 110 and 120 being capable of one or more actuations may also mean that various sensors are used to detect the different actuations. As described above with respect to FIG. 1A, the multi-modal control mechanisms 110 and 120 may be associated with one or more sensors that detect the different actuations of the control mechanisms. There may also be separate sensors for detecting the different actuations. However, in practical implementations, any given actuation may not be completely distinct from another actuation because any given actuation may also include other actuations to a lesser extent. For example, a push actuation may result from a force being applied to the multi-modal control mechanisms 110 and 120 along the z-axis, but when a user applies that force, that force may simultaneously be applied along the x-axis to a lesser extent than along the z-axis, which may also result in a shift actuation. As such, the control module of the manual control assembly that generates the input signals based on the actuations may generate the signals based on which of the detected actuations is greater.

Continuing with the example of a push actuation and a shift actuation, the multi-modal control mechanisms 110 and 120 may be associated with a first sensor (such as sensor 180A of FIG. 1D) for detecting the push actuation and a second sensor (such as sensor 180B) for detecting the shift actuation. When the multi-modal control mechanisms 110 and 120 are actuated, the first sensor may generate a measurement of the force or strain applied to the multi-modal control mechanisms 110 and 120 along the z-axis. The second sensor may generate a measure of the force or strain applied to the multi-modal control mechanisms 110 and 120 along the x-axis. The control module connected to the sensors may then analyze the measurements to determine which sensor's measurement is greater to determine the type of actuation of the multi-modal control mechanisms 110 and 120. The first sensor's measurement being greater than the second sensor's measurement may mean more force was applied along the z-axis than along the x-axis, indicating that the actuation was a push actuation. On the other hand, the second sensor's measurement being greater than the first sensor's measurement may mean more force was applied along the x-axis than along the z-axis, indicating that the actuation was a shift actuation.

The control module may also compare the difference between the first and second sensor's measurements along the different axes to a threshold when determining the type of actuation. The threshold may indicate the difference that should be present between the sensor's measurements along the different axes to be able to determine the type of actuation. The threshold difference being present between the sensors' measurements may indicate that one of the measurements is substantially greater than the other, which may provide a higher confidence that the determined actuation is correct. For example, a first measurement from the first sensor being substantially greater than a second measurement from the second sensor may provide a more confident indication that a push actuation was detected, while the first measurement being substantially less than the second measurement may provide a more confident indication that a shift actuation was detected.

In various embodiments, the difference between the first and second sensor's measurements not meeting the threshold may mean that no actuation was detected clearly and may lead to the user being prompted to actuate the multi-modal control mechanisms 110 and 120 again for the sensors to obtain measurements with a difference that does meet the threshold. In various other embodiments, the difference between the first and second sensor's measurements not meeting the threshold may mean that multiple types of actuations are detected, and the control module may proceed to generate corresponding input signals as such. It may also be noted that the description herein is described with respect to a push actuation that may be detected along with a shift actuation, but the descriptions may apply similarly in cases where any actuation is detected along with another actuation.

In various embodiments, and continuing with the example of a push actuation and a shift actuation, the multi-modal control mechanisms 110 and 120 may be associated with a first sensor for detecting the push actuation, and a second and third sensor for detecting the shift actuation. The first sensor may generate a measurement of the force or strain applied to the multi-modal control mechanisms 110 and 120 along the z-axis. The second sensor may generate a measure of the force or strain applied to the multi-modal control mechanisms 110 and 120 in a first direction along the x-axis (such as the force 710), and the third sensor may generate a measure of the force or strain applied to the multi-modal control mechanisms 110 and 120 in a second direction along the x-axis (such as the force 720). In various embodiments, the combination of the second and third sensors for detecting the shift actuation may increase the detection sensitivity and/or accuracy. The third sensor may also be positioned accordingly to be able to detect the shift actuations along the x-axis. This may mean that, similar to the second sensor, the third sensor is positioned orthogonal to the first sensor. Since the second sensor may also detect the shift actuations, the third sensor may be positioned parallel to the second sensor or on the same axis as the second sensor. In various embodiments, the sensors may leverage certain geometry that allows the third sensor to be positioned parallel to both the first and second sensors and still detect the push and shift actuations. This geometry may allow for the first, second, and third sensors to be installed on the same interface (e.g., a single PCB).

In the example of a push actuation and a shift actuation, the first, second, and third sensors may generate three measurements for any detected actuation. The control module connected to the sensors may then analyze the three measurements to determine which sensor's measurement is greatest to determine the type of actuation. The first sensor's measurement being greatest may indicate the actuation was a push actuation, the second sensor's measurement being greatest may indicate the actuation was a shift actuation in the first direction along the x-axis, and the third sensor's measurement being greatest may indicate the actuation was a shift actuation in the second direction along the x-axis.

The control module may also compare the difference between the three measurements of the three sensors to one or more thresholds when determining the actuation, similar to the description above. The one or more thresholds may indicate the differences that should be present between one or more of the three sensors to be able to determine the type of actuation. For example, a first threshold may indicate the difference that should be present between a first measurement of the first sensor and a second measurement of the second sensor or a third measurement of the third sensor to determine whether a push or shift actuation was detected. That is, the first threshold difference being present between the first and second or first and third sensors may indicate that the first measurement is substantially greater or substantially less than the second or third measurement, which in turn may indicate whether a push or shift actuation is detected. For example, in the case of a shift actuation, the first measurement may be substantially less than the second or third measurement, and the control module may generate corresponding signals based on that difference to indicate to the vehicle control system that a shift actuation was detected.

Additionally, and also in the case of a shift actuation, because the second and third measurements generated by the second and third sensors, respectively, may measure the force or strain in different directions, the control module may compare the difference between the second and third measurements to a second threshold to determine the direction of the detected actuation. Whether the second threshold difference is present may determine whether the second and third measurements are substantially different from one another to determine the direction of a shift actuation. The control module may then generate signals based on the second and third measurements being substantially different to indicate the direction of a shift actuation to the vehicle control system.

FIG. 8A illustrates a user interface for controlling a component of a vehicle through the multi-modal control mechanisms 110 and 120. As referenced herein, the user interface encompasses some or all the elements and controls that allow a user, such as the driver of a vehicle, to control the component of the vehicle, including visual elements that display information to the user (e.g., the visual component 800), input controls to receive input from the user (e.g., the multi-modal control mechanisms 110 and 120), feedback mechanisms that provide feedback in response to user input (e.g., the haptic actuators that generate haptic feedback as described above with respect to FIG. 1A-1D), and control systems that adjust the component based on the user input (e.g., control system 190). The visual component 800 of the user interface may be displayed on a display of the vehicle, such as the dash 310. In various embodiments, the visual component 800 may include a graphical user interface (GUI) that is displayed on a display of the vehicle. The visual component 800 may include graphical representations of the user control contexts corresponding to the multi-modal control mechanisms 110 and 120. The visual component 800 may include a graphical representation of a left user control context 810 and a graphical representation of a right user control context 820. Each of the graphical representations of the left and right user control contexts 810, 820 may include the component of the vehicle associated with the respective user control contexts and the current operational state of the component of the vehicle. As referenced herein, an operational state refers to a condition or state in terms of functionality, performance, and/or availability for operation.

The position of the graphical representations of the user control contexts in the visual component 800 may also indicate the multi-modal control mechanisms associated with the user control context. That is, the graphical representation of a user control context may be displayed on one side of the visual component 800, and the corresponding multi-modal control mechanism (and the manual control assembly that the multi-modal control mechanism is a part of) may be positioned on that same side of the steering controller. Specifically, the graphical representation of the left user control context 810 may be positioned on the left side of the visual component 800 and dash 310, and thus may correspond to the multi-modal control mechanism 110 that is positioned on the left side of the steering wheel 100 as shown in FIG. 1A. Similarly, the graphical representation of the right user control context 820 may be positioned on the right side of the visual component 800 and dash 310, and thus may correspond to the multi-modal control mechanism 120 that is positioned on the right side of the steering wheel as shown in FIG. 1A. The left and right positions of the user control contexts' graphical representation and the multi-modal control mechanisms 110 and 120 may be with respect to a user, such as the driver of the vehicle. In various embodiments, the association between the user control contexts 810 and 820 as displayed on the visual component 800 and the multi-modal control mechanisms 110 and 120 may be implicitly based on their respective positions with respect to a user (e.g., driver of the vehicle), but the graphical representations of the user control contexts in various embodiments may include an indication of which multi-modal control mechanism is associated with the respective user control context.

As illustrated in FIG. 8A, the multi-modal control mechanisms 110 and 120 may be associated with different user control contexts. That is, each multi-modal control mechanisms may be associated with its own user control context and control a component of the vehicle corresponding to that user control context. In various other embodiments, the multi-modal control mechanisms 110 and 120 may be associated with the same user control context. This means the multi-modal control mechanisms 110 and 120 may control the same vehicle component corresponding to that user control context. For example, the multi-modal control mechanisms 110 and 120 may be associated with a user control context corresponding to a vehicle's drivetrain, and the combination of the control mechanisms may allow a driver to control the drivetrain to perform various complex maneuvers, such as a tank turn where the vehicle spins around a central axis to change direction quickly without moving forward or backward. The present disclosure may be described with respect to the multi-modal control mechanisms 110 and 120 each being associated with a separate user control contexts, but the description may apply similarly in embodiments where the multi-modal control mechanisms 110 and 120 are associated with the same user control context.

As described above, the multi-modal control mechanisms 110 and 120 may be capable of various actuations to control the component of the vehicle corresponding to the left and right user control contexts 810 and 820. Each of the actuations may correspond to a particular control operation for the component of the vehicle, where a control operation may be an action performed on the component to manipulate the operational state and behavior of the component. That is, each of a scrolling actuation in an upwards or downwards direction, a shifting actuation in a leftwards or rightwards direction, a push actuation, and a press actuation may correspond to a specific control operation for a corresponding component of the vehicle. The graphical representations of the left and right user control contexts 810 and 820 may also include a schematic of the actuations and corresponding control operations based on the component of the vehicle corresponding to the user control contexts, with examples described below with respect to FIGS. 8B-8D. The schematics of the actuations and corresponding control operations may always be included in the graphical representations and displayed as part of the visual component 800, or the schematics may be included in response to user input, such as when the multi-modal control mechanisms 110 and 120 are capacitively actuated by the user making contact with them.

The graphical representations of the left and right user control contexts 810 and 820 may also include various information about the component of the vehicle associated with the user control contexts. The information may include the current operational state of the component and various other specific aspects of the component, as described below in the examples of FIGS. 8B-8D. The graphical representations of the user control contexts 810 and 820 may also include values that are used to control the operation of the vehicle component, which may also be part of the user control contexts 810 and 820. The values may determine the nature and extent of the control operation, and may be selected by a user via the actuations of the multi-modal control mechanisms 110 and 120. After a control operation, as determined by the corresponding values, is executed on the vehicle component, the graphical representation of the user control contexts 810 and 820 may also include the resulting operational state of the component as a result of executing the control operation.

FIGS. 8B-8D illustrate example control operations for various user control contexts corresponding to the actuations of the multi-modal control mechanisms 110 and 120. FIG. 8B illustrates example control operations for user control contexts that include the media and climate systems of a vehicle. In this example, the media system may correspond to the left user control context 810 and is thus associated with the multi-modal control mechanism 110, while the climate system may correspond to the right user control context 820 and is thus associated with the multi-modal control mechanism 120. The graphical representation of the left user control context 810 for the media system may include information specific to the media system, such as a volume bar 815 representing the current volume of the media system or a textual representation of the current song being played by the media system. On the other hand, the graphical representation of the right user control context 820 for the climate system may include information specific to the climate system, such as an air conditioning symbol 822 to indicate that the air conditioning is currently enabled, a numerical indication 824 of the temperature of the climate system, and a fan strength symbol 826 indicating the level of air being generated by the climate system.

The actuations of the multi-modal control mechanism 110 may correspond to control operations for adjusting various attributes of the media system. With directions being with respect to the driver of the vehicle, a scrolling actuation in an upwards direction may increase the volume, while a scrolling actuation in a downwards direction may decrease the volume. A shifting actuation in a rightwards direction may skip to the next track in a playlist, while a shifting actuation in a leftwards direction may reverse to the previous track in a playlist. A push actuation may pause the current track that is being played, and a press actuation may resume playback of the track.

The actuations of the multi-modal control mechanism 120 may correspond to control operations for adjusting various attributes of the climate system. A scrolling actuation in an upwards direction may increase the temperature, while a scrolling actuation in a downwards direction may decrease the temperature. A shifting actuation in a rightwards direction may increase the airflow from the air vents, while a shifting actuation in a leftwards direction may decrease the airflow from the air vents. A push actuation may enable the air conditioning, and a press actuation may disable the air conditioning.

Using the volume attribute of the media system as an example, the values used to control operation of the media system component as described above may be the specific volume levels for the media system. The scrolling actuations of the multi-modal control mechanism 110 in the upwards or downwards direction may allow a user to select a specific value or volume level for the media system, and a control operation may then be executed on the media system to adjust the volume to the value provided by the user through the multi-modal control mechanism 110. The resulting operational state of the media system with the adjusted volume may then be updated on the graphical representation of the user control context 810, such as the size of the volume bar 815 being updated to reflect the user's selection and the new operating state of the media system.

FIG. 8C illustrates example control operations for user control contexts that include the communication system and advanced driver assistance system (ADAS) of a vehicle. In this example, the communication system, which may be paired with a user's phone, may correspond to the left user control context 810 and is thus associated with the multi-modal control mechanism 110, while the climate system may correspond to the right user control context 820 and is thus associated with the multi-modal control mechanism 120. The graphical representation of the left user control context 810 for the communication system may include information specific to the communication system, such as the current mode for the system being the standard mode. On the other hand, the graphical representation of the right user control context 820 for the ADAS system may include information specific to the ADAS system, such as the current cruising speed being 65 miles per hour (mph) and the follow distance being 2.5 seconds from another vehicle at the cruising speed of 65 mph.

The actuations of the multi-modal control mechanism 110 may correspond to the control operations for adjusting various attributes of the communication system while it is paired with the user's phone. A scrolling actuation in an upwards direction may increase the volume or scroll through the phone contacts in a first direction, while a scrolling actuation in a downwards direction may decrease the volume or scroll through the phone contacts in a second direction. A shifting actuation in a leftwards or rightwards direction may put a current call on hold and scroll to other calls that were already on hold. A push actuation may end the current call or dismiss/reject an incoming call, while a press actuation may accept an incoming call or switch the active call to another on-hold call.

The actuations of the multi-modal control mechanism 120 may correspond to the control operations for adjusting various attributes of the ADAS system. A scrolling actuation in an upwards direction may increase the cruising speed, while a scrolling actuation in a downwards direction may decrease the cruising speed. A shifting actuation in a rightwards direction may increase the automatic follow distance, while a shifting actuation in a leftwards direction may decrease the automatic follow distance. A push actuation may enable the lane keeping feature, and a press actuation may disable the lane keeping feature.

FIG. 8D illustrates example control operations for user control contexts that include the driving dynamics system of a vehicle. In this example, each of the multi-modal control mechanisms 110 and 120 may be associated with a separate user control context, but the user control contexts may correspond to the same component of the vehicle, only different aspects of that component. As a result, the multi-modal control mechanisms 110 and 120 may be controlling the same component of the vehicle. That is, a user control context for some aspects of the driving dynamics system may correspond to the left user control context 810 and is associated with the multi-modal control mechanism 110, while other aspects of the driving dynamics system may correspond to the right user control context 820 and is associated with the multi-modal control mechanism 120. The graphical representation of the left user control context 810 may include information about certain aspects of the driving dynamics system, such as the vehicle having 314 miles of range remaining, the remaining amount of stored energy over time, and the current state of charge of the vehicle. On the other hand, the graphical representation of the right user control context 820 may include information about other aspects of the driving dynamics system, such as the current ride height, the driving mode, and the current pressure of the vehicle's wheels.

Starting with the multi-modal control mechanism 110, a scrolling actuation in an upwards direction may increase the amount of power or torque delivered to the vehicle's drivetrain to adjust responsiveness and acceleration characteristics, while a scrolling actuation in a downwards direction may decrease the power or torque delivered to the vehicle's drivetrain. A shifting actuation in a rightwards direction may increase the level of regenerative braking, while a shifting actuation in a leftwards direction may decrease the level of regenerative braking. A push actuation may enable cruise mode for the vehicle, while a press actuation may enable manual mode for the vehicle.

For the multi-modal control mechanism 120, a scrolling actuation in an upwards direction may increase the ride height of the vehicle, while a scrolling actuation in a downwards direction may decrease the ride height. A shifting actuation in a rightwards direction may change the vehicle to a conserve driving mode that reduces energy consumption, while a shifting actuation in a leftwards direction may change the vehicle to a sport driving mode that increases performance. A push actuation may enable four wheel drive, while a press actuation may enable two wheel drive, which may be front wheel drive or rear wheel drive.

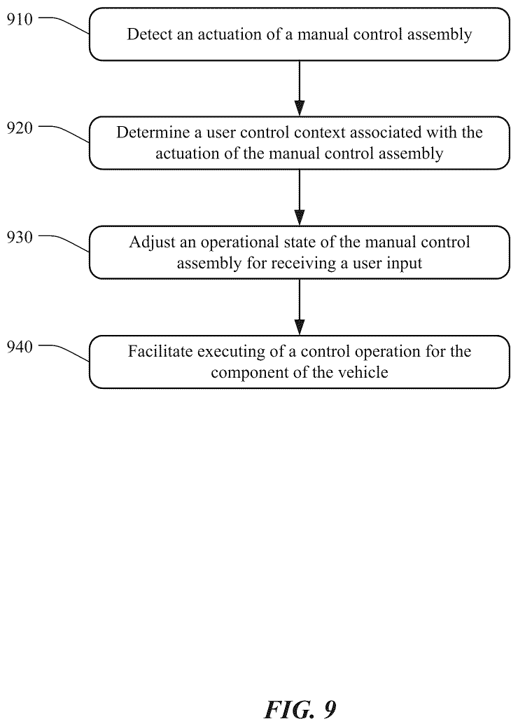

FIG. 9 illustrates steps in a method 900 for controlling a component of a vehicle. In various embodiments, method 900 may be executed by various components of the manual control assemblies 102 and 104 and the control system 190 of the vehicle. Method 900 may include step 910 where the control system of the vehicle may detect actuation of a manual control assembly positioned on a steering controller of the vehicle, such as either of manual control assemblies 102 and 104. The manual control assembly may be capable of a plurality of actuations, such as the scrolling, shifting, push, and press actuation as described above, with the detected actuation being one of the actuations that the manual control assembly is capable of. In various embodiments, detecting the actuation of the manual control assembly may include detecting an actuation of the multi-modal control mechanism of the manual control assembly, which may be detected by the sensors associated with the manual control assembly, with corresponding electrical signals being generated by a control module that are subsequently forwarded to the vehicle control system, as described above with respect to FIGS. 1A-1D.

At step 920, the control system of the vehicle may determine a user control context associated with the actuation of the manual control assembly. This may include determining the user control context that is associated with the multi-modal control mechanism of the manual control assembly, as the multi-modal control mechanism may be the component that is actuated by a user. In various embodiments, the relevant user control context may already be associated with the multi-modal control mechanism, and thus also the manual control assembly, prior to the actuation, such as in the examples as described above with respect to FIGS. 8A-8D.

At step 930, the control system of the vehicle may adjust the operational state of the manual control assembly for receiving a user input. That is, the actuation of the manual control assembly that was detected at step 910 may be a user input, and the operational state of the manual control assembly may be adjusted in response to receiving the user input. The adjusted operational state may also be based on the user control context associated with the manual control assembly as well as the user's selection of the values for controlling the component of the vehicle corresponding to the user control context. For example, and referring back to FIG. 8B, the user control context may include the media system of the vehicle, and the adjusted operational state may be based on user's selection of the volume for the media system. The user may actuate the multi-modal control mechanism 110 to input a selection for a particular volume level, and the adjusted operational state of the manual control assembly 102 that the multi-modal control mechanism 110 is a part may be based on that user selection of the particular volume level. In various embodiments, the adjusted operational state may include generating specific sensory feedback or engaging the braking mechanism of the manual control assembly.

At step 940, the control system of the vehicle may facilitate executing of a control operation for the component of the vehicle corresponding to the user control context that is associated with the actuated multi-modal control mechanism, or the manual control assembly that the control mechanism is a part of. The actuation of the manual control assembly that was detected at step 910 may indicate a user selection of the values used to control the component of the vehicle. For example, the detected actuation may indicate a user selection for a particular volume level for the media system of the vehicle. Accordingly, the control operation that is executed in step 940 may be the control operation to adjust the speaker of the vehicle that is part of the media system. Thus, the control system may facilitate execution of a control operation that is based on the user selection received via the actuated manual control assembly.

In various embodiments, as part of facilitating execution of the control operation, the control system may determine whether the control operation is able to be executed on the component of the vehicle. This may include measuring the current operational state of the component and then determining whether the current operational state is within predefined limits of operation for the component. The control operation may then be executed if the current operational state is within the predefined limits of operation. For example, the user may provide a user selection for a particular value for the volume of a media system. The control operation for the media system based on that user selection may be to increase the volume of the media system. The control system may measure the current volume of the media system, and then increase the volume if the volume is not already at the maximum volume level. However, if the volume is already at the maximum volume level, the control system may not facilitate execution of the control operation on the media system. The control system may subsequently update the graphical representation of the user control context corresponding to the actuated manual control assembly based on the results of executing the control operation. If the control operation was executed, the graphical representation may be updated with the resulting operation state of the component, as described above. If the control operation was not executed, the graphical representation may be updated with information about the current operational state, which may include a short description for why the control operation was not executed.

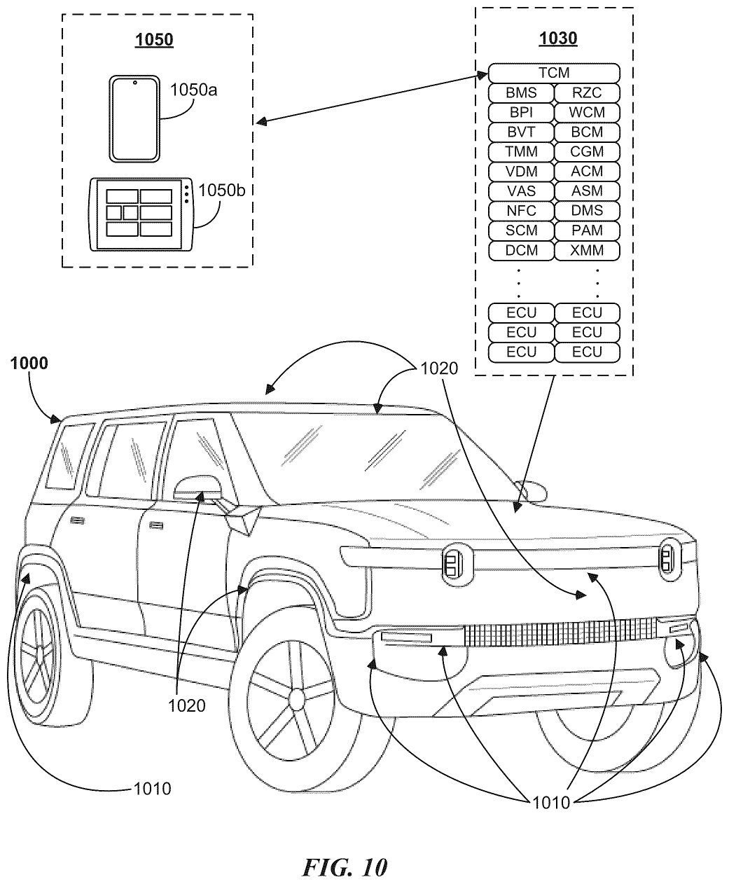

FIG. 10 illustrates an example vehicle 1000. Vehicle 1000 may include multiple sensors 1010, multiple cameras 1020, and a control system 1030. In some embodiments, vehicle 1000 may be able to pair with a computing device 1050 (e.g., smartphone 1050a, tablet computing device 1050b, or a smart vehicle accessory). As an example and not by way of limitation, a sensor 1010 may be an accelerometer, a gyroscope, a magnetometer, a global positioning satellite (GPS) signal sensor, a vibration sensor (e.g., piezoelectric accelerometer), a light detection and ranging (LiDAR) sensor, a radio detection and ranging (RADAR) sensor, an ultrasonic sensor, a temperature sensor, a pressure sensor, a humidity sensor, a chemical sensor, an electromagnetic proximity sensor, an electric current sensor, another suitable sensor, or a combination thereof. As an example and not by way of limitation, a camera 1020 may be a still image camera, a video camera, a 3D scanning system (e.g., based on modulated light, laser triangulation, laser pulse, structured light, light detection and ranging (LiDAR)), an infrared camera, another suitable camera, or a combination thereof. Vehicle 1000 may include various controllable components (e.g., doors, seats, windows, lights, HVAC, entertainment system, security system), instrument and information displays and/or interactive interfaces, functionality to pair a computing device 1050 with the vehicle (which may enable control of certain vehicle functions using the computing device 1050), and functionality to pair accessories with the vehicle, which may then be controllable through an interactive interface in the vehicle or through a paired computing device 1050.

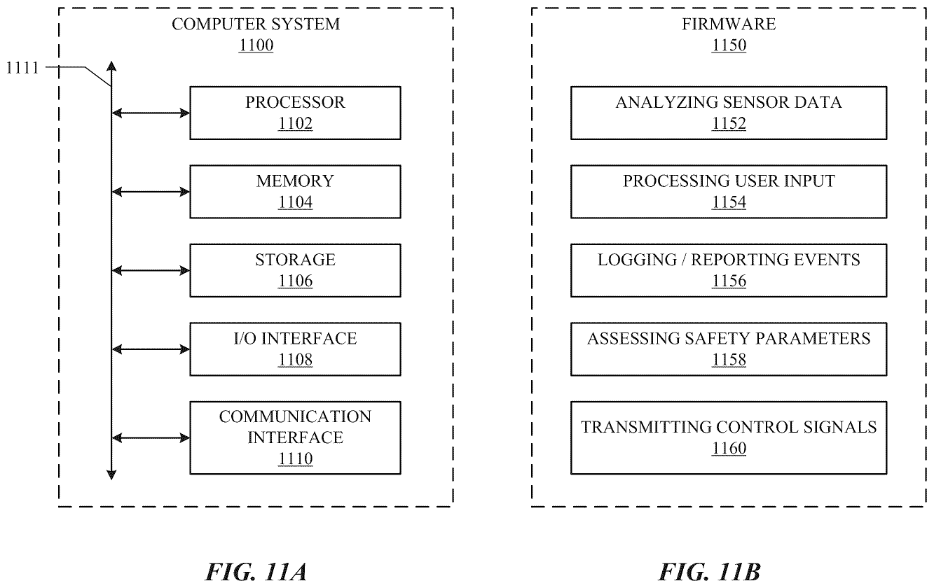

Control system 1030 may enable control of various systems on-board the vehicle. As shown in FIG. 10, control system 1030 may comprise one or more electronic control units (ECUs), each of which are dedicated to a specific set of functions. Each ECU may be a computer system (as described further in FIG. 11), and each ECU may include functionality provide by one or more of the example ECUs described below.

Features of embodiments as described herein may be controlled by one or more ECUs that provide functionality related to the battery pack of the vehicle. A Battery Management System (BMS) ECU may control and monitor a number of different aspects related to the electric vehicle battery system. Functions that may be controlled by the BMS may include, by way of example and not limitation, controlling the battery pack contactors and pre-charge relay, monitoring the high voltage connector, measuring the pack puncture sensor resistance and pack water sensor resistance, controlling the battery pack fans, measuring busbar temperature, communicating with the BPI and BVT ECUs, and calculate state-of-charge (SoC) and battery state-of-health (SoH). A Battery Power Isolation (BPI) ECU may provide high-voltage sensing, measure the battery pack current, and facilitate determination of pack isolation. A Balancing Voltage Temperature (BVT) ECU may monitor battery module cell voltages, monitor temperature, and execute cell balancing.

Features of embodiments as described herein may be controlled by a Thermal Management Module (TMM) ECU. The TMM ECU may provide electronic controls for HVAC components that control the temperature within a passenger cabin of the vehicle, including, by way of example and not limitation, sensing cabin temperature, heating and cooling of the cabin, and controlling HVAC mode (foot mode, defrost/demist), the electronic air compressor, the HVAC blower, the air vents, and the cabin heater. The TMM ECU may also or alternatively control heating and cooling of the battery pack and cooling of drive units (inverters), including, by way of example and not limitation, controlling the speed of the radiator fan, heating and cooling of energy storage system (ESS), monitoring ESS coolant temperature sensors, cooling of powertrain, and monitoring powertrain coolant temperature sensors.

Features of embodiments as described herein may be controlled by a Vehicle Dynamics Module (VDM) ECU. The VDM ECU may control a number of different functions related to aspects of the vehicle's drivetrain, regenerative braking, suspension, steering, traction control, distribution of mass, aerodynamics, and driving modes. In some embodiments, the VDM ECU may, by way of example and not limitation, control vehicle acceleration, control vehicle energy regeneration, calculate torque distribution, provide traction control, control drive modes, provide odometer functions, control driveline disconnects, adjust damping, adjust roll stiffness, adjust ride height, automatically level a vehicle when on a slope, and control the emergency parking brake driver.

Features of embodiments as described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device 1050, in-vehicle navigation, vehicle-to-vehicle communication, communication between the vehicle and landscape features (e.g., automated toll road sensors, automated toll gates, power dispensers at charging stations), or automated calling functionality.

Features of embodiments as described herein may be controlled by a Body Control Module (BCM) ECU. The BCM ECU may provide electronic controls for various components of the body of the vehicle, such as, by way of example and not limitation: interior lighting (e.g., cabin lights, seatbelt lights), exterior lighting (e.g., headlamps, side lights, rear lights, camp lights), power outlets, frunk switch, window wiper movement and washer fluid deployment, the overhead center console, horn, power ports, and wireless accessory charging and docking.

Features of embodiments as described herein may be controlled by a Central Gateway Module (CGM) ECU. The CGM ECU may serve as the vehicle's communications hub that connects and transfer data to and from the various ECUs, sensors, cameras, motors, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes. In some embodiments, for electric vehicles, the CGM ECU may also control the vehicle charge port door and related light(s) and sensor(s).

Features of embodiments as described herein may be controlled by one or more ECUs may provide functions of an automated driving system (ADS) and/or an advanced driver assistance system (ADAS) that may be enabled by a driver of the vehicle to provide one or more functions to support driving assistance and/or automation. An Autonomy Control Module (ACM) ECU may process data captured by cameras 1020 and/or sensors 1010. In some embodiments, the ACM ECU may provide artificial intelligence functionality to provide and/or refine functions to support driving assistance and/or automation. An Autonomous Safety Module (ASM) ECU may provide functions to support driving safety by monitoring sensors that support self-driving functions. A Driver Monitoring System (DMS) ECU may provide functionality to monitor and inform the control system about the driver's level of attention (e.g., while relying on driving assistance and/or automation functions). The DMS may process data captured by a camera positioned to monitor the driver's gaze. A Park Assist Module (PAM) ECU may provide functions to assist a driver during manual and/or automated parking operations. The PAM ECU may process data captured by cameras 1020 and/or sensors 1010 in order to determine appropriate control commands.

Features of embodiments as described herein may be controlled by an Experience Management Module (XMM) ECU may generate a user interface displayed on a dashboard of the vehicle. The user interface may display information and provide audio output for an infotainment system, including various views around and inside the vehicle. XMM may provide interactive controls for a number of different vehicle functions that may be controlled in conjunction with enabling the designated mode, such as, by way of example and not limitation: controlling interior and exterior lighting, vehicle displays (e.g., instrument cluster, center information display, and rear console display), audio output (e.g., audio processing, echo cancellation, beam focusing), music playback, heating, ventilation, and air conditioning (HVAC) controls, power settings, Wi-Fi connectivity, Bluetooth device connectivity, and vehicle leveling, as well as displaying information in the user interface (e.g., surround view camera feed, distance to nearest charger, and minimum range). In some embodiments, interactive controls provided by XMM may enable interaction with other modules of control system 1030. In some embodiments, functions of the ACM and the XMM may be combined together into an Autonomous experience Module (AXM) ECU.

Vehicle 1000 may include one or more additional ECUs, such as, by way of example and not limitation: a Vehicle Access System (VAS) ECU, a Near-Field Communication (NFC) ECU, a Seat Control Module (SCM) ECU, a Door Control Module (DCM) ECU, a Rear Zone Control (RZC) ECU, and/or a Winch Control Module (WCM) ECU. If vehicle 1000 is an electric vehicle, one or more ECUs may provide functionality related to the battery pack of the vehicle, such as a Battery Power Isolation (BPI) ECU, and/or a Balancing Voltage Temperature (BVT) ECU.

FIG. 11A illustrates an example computer system 1100. Computer system 1100 may include a processor 1102, memory 1104, storage 1106, an input/output (I/O) interface 1108, a communication interface 1110, and a bus 1112. Although this disclosure describes one example computer system including specified components in a particular arrangement, this disclosure contemplates any suitable computer system with any suitable number of any suitable components in any suitable arrangement. As an example and not by way of limitation, computer system 1100 may be an electronic control unit (ECU), an embedded computer system, a system-on-chip, a single-board computer system, a desktop computer system, a laptop or notebook computer system, a mainframe, a mesh of computer systems, a mobile telephone, a personal digital assistant, a server computing system, a tablet computer system, or a combination of two or more of these. Where appropriate, computer system 1100 may include one or more computer systems 1100; be unitary or distributed, span multiple locations, machines, or data centers; or reside in a cloud, which may include one or more cloud components in one or more networks. Where appropriate, computer system(s) 1100 may perform, at different times or at different locations, in real time or in batch mode, one or more steps of one or more methods described or illustrated herein.

Processor 1102 (e.g., compute units 1122 and 1132) may include hardware for executing instructions, such as those making up a computer program. As an example and not by way of limitation, to execute instructions, processor 1102 may retrieve (or fetch) the instructions from an internal register, an internal cache, memory 1104, or storage 1106; decode and execute them; and then write one or more results to an internal register, an internal cache, memory 1104, or storage 1106 (e.g., storage units 1124 and 1134). Processor 1102 may include one or more internal caches for data, instructions, or addresses.

In particular embodiments, memory 1104 includes main memory for storing instructions for processor 1102 to execute or data for processor 1102 to operate on. In particular embodiments, one or more memory management units (MMUs) reside between processor 1102 and memory 1104 and facilitate accesses to memory 1104 requested by processor 1102. In particular embodiments, memory 1104 includes random access memory (RAM). This disclosure contemplates any suitable RAM.

In particular embodiments, storage 1106 includes mass storage for data or instructions. As an example and not by way of limitation, storage 1106 may include a removable disk drive, flash memory, an optical disc, a magneto-optical disc, magnetic tape, or a Universal Serial Bus (USB) drive or two or more of these. Storage 1106 may include removable or fixed media and may be internal or external to computer system 1100. Storage 1106 may include any suitable form of non-volatile, solid-state memory or read-only memory (ROM).

In particular embodiments, I/O interface 1108 includes hardware, software, or both, providing one or more interfaces for communication between computer system 1100 and one or more input and/or output (I/O) devices. Computer system 1100 may be communicably connected to one or more of these I/O devices, which may be incorporated into, plugged into, paired with, or otherwise communicably connected to vehicle 1000 (e.g., through the TCM ECU). An input device may include any suitable device for converting volitional user input into digital signals that can be processed by computer system 1100, such as, by way of example and not limitation, a steering controller, a touch screen, a microphone, a joystick, a scroll wheel, a button, a toggle, a switch, a dial, or a pedal. An input device may include one or more sensors for capturing different types of information, such as, by way of example and not limitation, sensors 1010 described above. An output device may include devices designed to receive digital signals from computer system 1100 and convert them to an output format, such as, by way of example and not limitation, speakers, headphones, a display screen, a heads-up display, a lamp, a smart vehicle accessory, another suitable output device, or a combination thereof. This disclosure contemplates any suitable I/O devices and any suitable I/O interfaces 1108 for them. I/O interface 1108 may include one or more I/O interfaces 1108, where appropriate.

In particular embodiments, communication interface 1110 includes hardware, software, or both providing one or more interfaces for data communication between computer system 1100 and one or more other computer systems 1100 or one or more networks.

Communication interface 1110 may include one or more interfaces to a controller area network (CAN) or to a local interconnect network (LIN). Communication interface 1110 may include one or more of a serial peripheral interface (SPI) or an isolated serial peripheral interface (isoSPI). In some embodiments, communication interface 1110 may include a network interface controller (NIC) or network adapter for communicating with an Ethernet or other wire-based network or a wireless NIC (WNIC) or wireless adapter for communicating with a wireless network, such as a WI-FI network or a cellular network.

In particular embodiments, bus 1112 includes hardware, software, or both coupling components of computer system 1100 to each other. Bus 1112 may include any suitable bus, as well as one or more buses 1112, where appropriate. Although this disclosure describes a particular bus, any suitable bus or interconnect is contemplated.

Herein, a computer-readable non-transitory storage medium or media may include one or more semiconductor-based or other integrated circuits (ICs) (such, as for example, field-programmable gate arrays or application-specific ICs), hard disk drives, hybrid hard drives, optical discs, optical disc drives, magneto-optical discs, magneto-optical drives, solid-state drives, RAM drives, any other suitable computer-readable non-transitory storage media, or any suitable combination. A computer-readable non-transitory storage medium may be volatile, non-volatile, or a combination of volatile and non-volatile, where appropriate.

FIG. 11B illustrates example firmware 1150 for a vehicle ECU 1100 as described with respect to control system 1030. Firmware 1150 may include functions 1152 for analyzing sensor data based on signals received from sensors 1010 or cameras 1020 received through communication interface 1110. Firmware 1150 may include functions 1154 for processing user input (e.g., directly provided by a driver of or passenger in vehicle 1000, or provided through a computing device 1050) received through I/O interface 1108. Firmware 1150 may include functions 1156 for logging detected events (which may be stored in storage 1106 or uploaded to the cloud), as well as functions for reporting detected events (e.g., to a driver or passenger of the vehicle through an instrument display or interactive interface of the vehicle, or to a vehicle manufacturer, service provider, or third party through communication interface 1110). Firmware 1150 may include functions 1158 for assessing safety parameters (e.g., monitoring the temperature of a vehicle battery or the distance between vehicle 1000 and nearby vehicles). Firmware 1150 may include functions 1160 for transmitting control signals to components of vehicle 1000, including other vehicle ECUs 1100.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

### EXAMPLE EMBODIMENTS

Embodiments disclosed herein may include:
1. A manual control assembly, comprising:
a multi-modal control mechanism;
a connection socket for housing the multi-modal control mechanism on a steering controller of a vehicle, wherein an interface of the connection socket is connected to a control system for the vehicle;
a first sensor and a second sensor for detecting actuation of the multi-modal control mechanism, wherein the first sensor is positioned orthogonal to the second sensor to detect a force applied to the multi-modal control mechanism; and a control module for generating, based on the actuation, input signals to be transmitted to the control system to control one or more components of the vehicle.
2 The manual control assembly of embodiment 1, wherein the multi-modal control mechanism is capable of bidirectional actuation by spinning the multi-modal control mechanism around a central rotational axis.
3 The manual control assembly of embodiment 2, wherein the input signals are generated based on a detected measurement related to rotation of the multi-modal control mechanism around the central rotational axis, the detected measurement comprising at least one of an angle of rotation, a speed of rotation, an acceleration of rotation, or a rotational force.
4. The manual control assembly of embodiment 2, wherein the multi-modal control mechanism is capable of bidirectional actuation by applying a force to the multi-modal control mechanism along a first axis perpendicular to the central rotational axis and substantially non-parallel to a plane of rotation of the steering controller.
5. The manual control assembly of embodiment 4, wherein the input signals are generated based on a first measurement from the first sensor being substantially greater than a second measurement from the second sensor, wherein the first measurement or the second measurement comprises a force measurement or a strain measurement.
6 The manual control assembly of embodiment 4, wherein the input signals are generated based on a detected measurement related to actuation of the multi-modal control mechanism along the first axis, the detected measurement comprising at least one of: a direction, a speed, a magnitude of force, a pressure, or a duration.
7. The manual control assembly of embodiment 2, wherein the multi-modal control mechanism is capable of bidirectional actuation by applying a force to the multi-modal control mechanism along a second axis parallel to the central rotational axis and substantially parallel to a plane of rotation of the steering controller.
8 The manual control assembly of embodiment 7, wherein the input signals are generated based on a first measurement from the first sensor being substantially less than a second measurement from the second sensor, wherein the first measurement or the second measurement comprises a force measurement or a strain measurement.
9 The manual control assembly of embodiment 8, further comprising a third sensor positioned orthogonal to the first sensor and positioned parallel to the second sensor, and wherein the input signals are generated based on a first measurement from the first sensor being substantially less than a second measurement from the second sensor or a third measurement from the third sensor, wherein the first measurement, the second measurement, or the third measurement comprises a force measurement or a strain measurement.
10. The manual control assembly of embodiment 8, further comprising a third sensor positioned orthogonal to the first sensor and positioned parallel to the second sensor, and wherein the input signals are generated based on a second measurement from the second sensor being substantially different from a third measurement from the third sensor, wherein the second measurement or the third measurement comprises a force measurement or a strain measurement.
11. The manual control assembly of embodiment 7, wherein the input signals are generated based on a detected measurement related to actuation of the multi-modal control mechanism along the second axis, the detected measurement comprising at least one of: a direction, a speed, a magnitude of force, a pressure, or a duration.
12. The manual control assembly of embodiment 1, further comprising a motor housed within the multi-modal control mechanism or a housing component of the connection socket.
13. The manual control assembly of embodiment 1, further comprising a braking mechanism, wherein a level of resistance applied to the multi-modal control mechanism by the braking mechanism is determined by the control system.
14. The manual control assembly of embodiment 1, wherein a surface of the multi-modal control mechanism comprises capacitive touch sensors, and wherein the manual control assembly is capable of generating input signals based on activation of the capacitive touch sensors.
15. The manual control assembly of embodiment 1, wherein a surface of the multi-modal control mechanism comprises pressure sensors, and wherein the manual control assembly is capable of generating input signals based on activation of the pressure sensors.
16. The manual control assembly of embodiment 1, further comprising a haptic actuator, wherein the manual control assembly is capable of generating haptic feedback using the haptic actuator based on signals received from the control system.
17. A steering controller configured for installation in a vehicle, comprising:
a pair of manual control assemblies, each of the manual control assemblies comprising:
   a multi-modal control mechanism capable of bidirectional actuation around a central rotational axis and bidirectional actuation along one or more axes; and
   a connection socket for housing the multi-modal control mechanism on the steering controller, wherein an interface of the connection socket is connected to a control system for the vehicle;
wherein each of the manual control assemblies is capable of transmitting input signals to the control system to control components of the vehicle and capable of receiving feedback signals from the control system.
18. The steering controller of embodiment 17, wherein the pair of manual control assemblies are positioned on opposite sides of the steering controller, and wherein the multi-modal control mechanism of each of the manual control assemblies is reachable by a driver's hand while positioned on the steering controller for normal driving operation.
19. The steering controller of embodiment 17, wherein each of the manual control assemblies is associated with a user control context, and wherein the input signals from each of the manual control assemblies are transmitted in accordance with the user control context.
20. A control system for a vehicle, comprising:
an electronic control unit comprising a processor and a non-transitory computer-readable medium comprising instructions executable to control one or more functions of the vehicle;
a steering controller;
a pair of manual control assemblies incorporated into the steering controller, each of the manual control assemblies comprising:
   a multi-modal control mechanism capable of bidirectional spinning around a central rotational axis; and
   a connection socket for housing the multi-modal control mechanism on the steering controller of the vehicle, wherein an interface of the connection socket is connected to a control system for the vehicle;
wherein the manual control assemblies are capable of transmitting input signals to the electronic control unit to control components of the vehicle.

1. A manual control assembly, comprising:
a multi-modal control mechanism;
a connection socket for housing the multi-modal control mechanism on a steering controller of a vehicle, wherein an interface of the connection socket is connected to a control system for the vehicle;
a first sensor and a second sensor for detecting actuation of the multi-modal control mechanism, wherein the first sensor is positioned orthogonal to the second sensor to detect a force applied to the multi-modal control mechanism; and
a control module for generating, based on the actuation, input signals to be transmitted to the control system to control one or more components of the vehicle.

2. The manual control assembly of claim 1, wherein the multi-modal control mechanism is capable of bidirectional actuation by spinning the multi-modal control mechanism around a central rotational axis.

3. The manual control assembly of claim 2, wherein the input signals are generated based on a detected measurement related to rotation of the multi-modal control mechanism around the central rotational axis, the detected measurement comprising at least one of an angle of rotation, a speed of rotation, an acceleration of rotation, or a rotational force.

4. The manual control assembly of claim 2, wherein the multi-modal control mechanism is capable of bidirectional actuation by applying a force to the multi-modal control mechanism along a first axis perpendicular to the central rotational axis and substantially non-parallel to a plane of rotation of the steering controller.

5. The manual control assembly of claim 4, wherein the input signals are generated based on a first measurement from the first sensor being substantially greater than a second measurement from the second sensor, wherein the first measurement or the second measurement comprises a force measurement or a strain measurement.

6. The manual control assembly of claim 4, wherein the input signals are generated based on a detected measurement related to actuation of the multi-modal control mechanism along the first axis, the detected measurement comprising at least one of: a direction, a speed, a magnitude of force, a pressure, or a duration.

7. The manual control assembly of claim 2, wherein the multi-modal control mechanism is capable of bidirectional actuation by applying a force to the multi-modal control mechanism along a second axis parallel to the central rotational axis and substantially parallel to a plane of rotation of the steering controller.

8. The manual control assembly of claim 7, wherein the input signals are generated based on a first measurement from the first sensor being substantially less than a second measurement from the second sensor, wherein the first measurement or the second measurement comprises a force measurement or a strain measurement.

9. The manual control assembly of claim 8, further comprising a third sensor positioned orthogonal to the first sensor and positioned parallel to the second sensor, and wherein the input signals are generated based on a first measurement from the first sensor being substantially less than a second measurement from the second sensor or a third measurement from the third sensor, wherein the first measurement, the second measurement, or the third measurement comprises a force measurement or a strain measurement.

10. The manual control assembly of claim 8, further comprising a third sensor positioned orthogonal to the first sensor and positioned parallel to the second sensor, and wherein the input signals are generated based on a second measurement from the second sensor being substantially different from a third measurement from the third sensor, wherein the second measurement or the third measurement comprises a force measurement or a strain measurement.

11. The manual control assembly of claim 7, wherein the input signals are generated based on a detected measurement related to actuation of the multi-modal control mechanism along the second axis, the detected measurement comprising at least one of: a direction, a speed, a magnitude of force, a pressure, or a duration.

12. The manual control assembly of claim 1, further comprising a motor housed within the multi-modal control mechanism or a housing component of the connection socket.

13. The manual control assembly of claim 1, further comprising a braking mechanism, wherein a level of resistance applied to the multi-modal control mechanism by the braking mechanism is determined by the control system.

14. The manual control assembly of claim 1, wherein a surface of the multi-modal control mechanism comprises capacitive touch sensors, and wherein the manual control assembly is capable of generating input signals based on activation of the capacitive touch sensors.

15. The manual control assembly of claim 1, wherein a surface of the multi-modal control mechanism comprises pressure sensors, and wherein the manual control assembly is capable of generating input signals based on activation of the pressure sensors.

16. The manual control assembly of claim 1, further comprising a haptic actuator, wherein the manual control assembly is capable of generating haptic feedback using the haptic actuator based on signals received from the control system.

17. A steering controller configured for installation in a vehicle, comprising:
a pair of manual control assemblies, each of the manual control assemblies comprising:
a multi-modal control mechanism capable of bidirectional actuation around a central rotational axis and bidirectional actuation along one or more axes; and
a connection socket for housing the multi-modal control mechanism on the steering controller, wherein an interface of the connection socket is connected to a control system for the vehicle;
wherein each of the manual control assemblies is capable of transmitting input signals to the control system to control components of the vehicle and capable of receiving feedback signals from the control system.

18. The steering controller of claim 17, wherein the pair of manual control assemblies are positioned on opposite sides of the steering controller, and wherein the multi-modal control mechanism of each of the manual control assemblies is reachable by a driver's hand while positioned on the steering controller for normal driving operation.

19. The steering controller of claim 17, wherein each of the manual control assemblies is associated with a user control context, and wherein the input signals from each of the manual control assemblies are transmitted in accordance with the user control context.

20. A control system for a vehicle, comprising:
an electronic control unit comprising a processor and a non-transitory computer-readable medium comprising instructions executable to control one or more functions of the vehicle;
a steering controller;
a pair of manual control assemblies incorporated into the steering controller, each of the manual control assemblies comprising:
a multi-modal control mechanism capable of bidirectional spinning around a central rotational axis; and
a connection socket for housing the multi-modal control mechanism on the steering controller of the vehicle, wherein an interface of the connection socket is connected to a control system for the vehicle;
wherein the manual control assemblies are capable of transmitting input signals to the electronic control unit to control components of the vehicle.
